(19) United States
(12) Patent Application Publication
(10) Pub. No.: US 2011/0268922 A1
(43) Pub. Date: Nov. 3, 2011

(54) BONDED PRODUCT AND MANUFACTURING METHOD AND MANUFACTURING DEVICE THEREFOR

(75) Inventors: Katsuya Matsumoto, Tochigi-ken (JP); Sumitomo Watanabe, Tochigi-ken (JP); Mitsugu Kaneko, Tochigi-ken (JP); Toshihiro Murakawa, Tochigi-ken (JP); Takahiro Morita, Tochigi-ken (JP)

(73) Assignee: HONDA MOTOR CO., LTD., MINATO-KU, TOKYO (JP)

(21) Appl. No.: 13/130,872

(22) PCT Filed: Nov. 20, 2009
(86) PCT No.: PCT/JP2009/069686

§ 371 Date: May 24, 2011

(30) Foreign Application Priority Data
Nov. 26, 2008 (JP) 2008-301002
Nov. 26, 2008 (JP) 2008-301009
Nov. 26, 2008 (JP) 2008-301014
Apr. 27, 2009 (JP) 2009-108382
Apr. 27, 2009 (JP) 2009-108387
Jul. 13, 2009 (JP) 2009-164765

(51) Int. Cl. B32B 3/00; B22D 27/08; B22D 27/11; B22D 19/00; B22C 9/00

(52) U.S. Cl. 428/156; 164/98; 164/319; 164/103; 164/105; 164/71.1

(57) ABSTRACT

Disclosed are a bonded product, and a manufacturing method and manufacturing device therefor. To obtain a bonded product formed of a solidified material of a molten metal which has been poured into a forming mold with a workpiece, all or part of which is already held therein, or formed of a semi-solidified slurry which is contained in the forming mold together with the workpiece, the semi-solidified slurry or the molten metal is relatively made to flow on the end faces of the workpiece while friction sufficient to break the passive state existing at the surface of the molten metal or the semi-solidified slurry is generated between the workpiece and the semi-solidified slurry or the molten metal.

### TECHNICAL FIELD

The present invention relates to a joined article (bonded product) produced by joining a semi-solidified slurry or a solidified body of molten metal to a workpiece, a method of manufacturing such a joined article, and an apparatus (device) for manufacturing a joined article by stamping and joining a semi-solidified slurry to a workpiece.

### BACKGROUND ART

There is known a so-calling insert molding process for joining metal materials of different compositions (different alloy types) to each other to produce a joined article. According to the insert molding process, a workpiece of metal (insert) is placed in a mold, and a molten metal which is of a different alloy type from the workpiece is poured into the mold and solidified. The molten metal is brought into close contact with the workpiece according to the shape of the cavity in the casting mold, and turned into a solidified body. At this time, the solidified body is joined to the workpiece.

According to another process, injection molding is performed using a semi-solidified slurry. Specifically, a workpiece is placed in a mold, and the mold is clamped. Thereafter, a semi-solidified slurry is poured into the mold whereupon it is molded into a shape complementary to the cavity in the mold and joined to the workpiece (see, for example, Japanese Laid-Open Patent Publication No. 2001-058253). The term “semi-solidified slurry” refers to a slurry in a coexisting solid-liquid phase, as described in Japanese Laid-Open Patent Publication No. 2001-058253. Generally, a semi-solidified slurry is soft to the extent that it exhibits flowability only when pressurized.

However, either the insert molding process or the injection molding process finds it difficult to increase the joining strength by which the metal materials of different alloy types are joined to each other. The difficulty manifests itself particularly when the insert molding is performed using a workpiece made of aluminum and a molten metal made of an aluminum alloy. The difficulty is considered to arise from the existence of an oxide film on the interface between the workpiece and the molten metal or the semi-solidified slurry.

In view of the above difficulty, according to the invention disclosed in Japanese Laid-Open Patent Publication No. 10-099961, it is attempted to press a molten metal (semi-solidified slurry) at a coexisting solid-liquid phase temperature against a workpiece thereby to remove an oxide film off the surface of the workpiece in an insert molding process.

Japanese Laid-Open Patent Publication No. 50-089215 proposes applying vibrations to an aluminum plate. According to Japanese Laid-Open Patent Publication No. 50-089215, an oxide film is removed from the aluminum plate by the applied vibrations, allowing the aluminum plate and an aluminum alloy to be held in direct and close contact with each other for increased joining strength.

It is hard for a molten metal (semi-solidified slurry) in a coexisting solid-liquid phase to start flowing. Therefore, when a molten metal is injected into a mold as disclosed in Japanese Laid-Open Patent Publication No. 10-099961, the molten metal has a tendency to solidify while flowing in the mold. If the molten metal is solidified to the extent that it stops flowing, then the molten metal fails to reach regions in the mold, resulting in a mold filling failure. In other words, it is not easy to produce insert-molded articles efficiently.

The above deficiency is serious especially when large articles are insert-molded because a molten metal flows a large distance in the mold and accordingly a large amount of the molten metal needs to be supplied in order to fill the mold with the molten metal.

In addition, if the semi-solidified slurry is of an aluminum alloy or the like, an oxide film is easily formed on the surface thereof. Consequently, it is not easy to keep the semi-solidified slurry wet enough with respect to the workpiece, and hence it is not easy to increase the joining strength between the workpiece and the semi-solidified slurry after the injection molding process.

According to the background art disclosed in Japanese Laid-Open Patent Publication No. 2001-058253 and Japanese Laid-Open Patent Publication No. 10-099961, only a semi-solidified slurry is molded. Therefore, after a workpiece is pressed to shape, it needs to be carried to an insert-molding mold. Since the three processes of pressing, carrying, and insert molding have to be performed, it takes a long time before a joined article is obtained.

Furthermore, an intensive study conducted by the inventor of the present invention has indicated that when vibrations are applied to the molten metal uninterruptedly from the start of the process for pouring the molten metal until the end of the process for pouring the molten metal, as disclosed in Japanese Laid-Open Patent Publication No. 50-089215, cavities are liable to develop in the solidified body.

Since the cavities are void, the solidified body is less strong and less ductile in regions near the cavities. Therefore, the background art disclosed in Japanese Laid-Open Patent Publication No. 50-089215 raises concerns about some difficulty in keeping enough strength and ductility of the solidified body.

### SUMMARY OF THE INVENTION

It is a general object of the present invention to provide a joined article in which an insert and a material molded around the insert are joined to each other with an increased joining strength.

A major object of the present invention is to provide a joined article with cavities prevented from being formed therein.

Another object of the present invention is to provide a method of manufacturing the above joined article.

Still another object of the present invention is to provide an apparatus for manufacturing a joined article in which a workpiece and a semi-solidified slurry are joined to each other with an increased joining strength.

Yet another object of the present invention is to provide an apparatus for manufacturing a joined article in a reduced period of time.

Yet still another object of the present invention is to provide a stamping method which is capable of removing an oxide film of a semi-solidified slurry.

According to the present invention, for obtaining a joined article of a workpiece which is partly or wholly previously placed in a mold assembly and a solidified mass of a molten metal poured in the mold assembly or a semi-solidified slurry which is previously placed, together with the workpiece, in the mold assembly, the semi-solidified slurry or the molten metal is caused to flow relatively on an end face of the workpiece while producing friction between the workpiece and the semi-solidified slurry or the molten metal, the friction being large enough to break a passivation film which is present on a surface of the molten metal or the semi-solidified slurry.

The term “flow relatively” includes a case wherein the semi-solidified slurry or the molten metal flows on the end face of the workpiece which is held at rest, a case wherein the workpiece moves with respect to the semi-solidified slurry or the molten metal which is held at rest, and a case wherein the workpiece moves with respect to the semi-solidified slurry or the molten metal which is flowing.

According to a first embodiment of the present invention in view of the above concept, there is provided a method of manufacturing a joined article, comprising the steps of:

placing at least one semi-solidified slurry and at least two workpieces in a mold assembly;

clamping the mold assembly to mold the semi-solidified slurry complementarily in shape to a cavity, and causing the semi-solidified slurry to flow to respective insert-molded regions of the workpieces; and

solidifying the semi-solidified slurry;

wherein the semi-solidified slurry which has flowed to the insert-molded regions is insert-molded around the insert-molded regions.

According to the present invention, in a stamping process, the semi-solidified slurry is pressed against the workpiece and brought into sliding contact with an insert-molded region of the workpiece. The sliding contact increases frictional forces between the semi-solidified slurry and the insert-molded region, with the result that a passivation film (oxide film) that is present on the surface of the semi-solidified slurry is broken, causing an internal slurry to flow out.

The slurry that has flowed out has no oxide film, and thus has good wettability with respect to the insert-molded region. According to the present invention, therefore, the insert-molded region of the workpiece is well wetted by the slurry. As the slurry is then solidified into a solidified mass, the solidified mass and the workpiece are firmly joined to each other. Stated otherwise, it is possible to produce an insert-molded article of excellent joining strength from metal materials of alloy types which are different from each other.

According to the present invention, furthermore, a molten metal which is in a coexisting solid-liquid phase as in an injection molding process is prevented from being solidified while flowing, and hence no filling failure occurs. Consequently, even insert-molded articles of large size can efficiently be manufactured.

The mold assembly may be clamped with the semi-solidified slurry being disposed between the workpieces or with the semi-solidified slurry being disposed on the workpieces.

According to a second embodiment of the present invention, there is provided a method of manufacturing a joined article by joining a semi-solidified slurry and a workpiece which are placed in a mold assembly to each other, comprising the steps of:

forming a ridge on the mold assembly or the workpiece in an area through which the semi-solidified slurry flows;

causing the ridge to form a restriction when the mold assembly is clamped to form a cavity;

applying a load to the semi-solidified slurry thereby to cause the semi-solidified slurry to flow through the restriction; and

joining at least a region of the workpiece which is positioned upstream of the ridge with respect to a direction in which the semi-solidified slurry flows, to the semi-solidified slurry.

According to the present invention, the restriction increases a flow resistance of the semi-solidified slurry. The semi-solidified slurry with the increased flow resistance presses the ridge of the restriction with large forces. In other words, the force with which the semi-solidified slurry presses the ridge increases.

Therefore, frictional forces between the semi-solidified slurry and the ridge increase. As a result, a passivation film (oxide film) that is present on the surface of the semi-solidified slurry is broken, causing an internal unsolidified slurry to flow out.

The slurry has good wettability with respect to the workpiece. According to the present invention, therefore, the workpiece is well wetted by the slurry. As the slurry is solidified into a molded body, the molded body and the workpiece are firmly joined to each other. Stated otherwise, it is possible to produce an insert-molded article of excellent joining strength from metal materials of alloy types which are different from each other.

If the flow resistance is excessively increased by the restriction, it will not be easy to fill the cavity with the semi-solidified slurry. Therefore, the restriction should preferably have a cross-sectional area reduction ratio in the range from 10 to 40%.

According to a third embodiment of the present invention, there is provided a method of manufacturing a joined article by joining a semi-solidified slurry and a workpiece to each other, comprising the steps of:

supporting the workpiece with a first mold;

placing the semi-solidified slurry on an end face of the workpiece;

forming a space surrounding the semi-solidified slurry with the end face of the workpiece, a second mold, and a slurry outflow preventing member; and

pressing the semi-solidified slurry with the second mold to slide on the end face of the workpiece;

wherein the slurry outflow preventing member blocks the semi-solidified slurry which flows by being pressed by the second mold.

According to an injection molding process, a semi-solidified slurry mainly flows only, with its surface layer not sufficiently pressed against the workpiece. Therefore, the semi-solidified slurry is not compressed, and its surface layer is not cracked.

According to the present invention, a stamping process is performed to press the semi-solidified slurry against the end face of the workpiece. The surface layer of the semi-solidified slurry has a higher solid phase ratio than the inside thereof. In the present invention, therefore, the surface layer of high solid phase ratio is held in sliding contact with the end face of the workpiece. Consequently, an oxide film on the surface layer is efficiently removed.

According to the present invention, furthermore, the surface layer of the semi-solidified slurry pressed by a slurry pressing mold, i.e., the oxide film, is cracked because the semi-solidified slurry is pressed and compressed.

The slurry which is not oxidized flows out through the crack and starts to flow along the end face of the workpiece. The slurry which is not oxidized wets and closely contacts various metal materials well, and is subsequently cooled and solidified into a molded body. As a consequence, no oxide film is formed between the workpiece and the slurry. Therefore, a joined article of excellent joining strength is produced by mutual diffusion while the slurry is being cooled.

Preferably, the workpiece is pressed by a third mold to shape the workpiece. In this case, both the semi-solidified slurry and the workpiece can be shaped by one manufacturing apparatus. Accordingly, the investments for equipment can be lowered, and the joined article can efficiently be produced in a short time.

According to the third embodiment of the present invention, there is provided an apparatus for manufacturing a joined article by joining a semi-solidified slurry and a workpiece to each other, comprising:

a first mold for supporting the workpiece;

a second mold for pressing the semi-solidified slurry which is placed on an end face of the workpiece; and

a slurry outflow preventing member which cooperates with the end face of the workpiece and the second mold to define a space surrounding the semi-solidified slurry;

wherein the slurry outflow preventing member blocks the semi-solidified slurry which flows by being pressed by the second mold.

With the above arrangement, a joined article of excellent joining strength can be produced easily, as described above.

If the apparatus further includes a third mold for pressing the workpiece, and the third mold shapes the workpiece, then both the semi-solidified slurry and the workpiece can be shaped by one manufacturing apparatus. The joined article can thus be produced efficiently in a short time. As the investments for equipment are reduced, the apparatus is advantageous in cost.

The workpiece outflow preventing member and the third mold may be provided as one member or separate members.

According to a fourth embodiment of the present invention, there is provided a joined article which is insert-molded such that an end of a workpiece is surrounded by a solidified mass of a semi-solidified slurry,

wherein the end breaks through an oxide film on the surface of the solidified mass and is joined to the solidified mass in the inside of the solidified mass where no oxide film is present.

According to the present invention, the end of the workpiece is embedded in a region of the semi-solidified slurry where there is no oxide film, i.e., a region where metal surfaces of the semi-solidified slurry are exposed, and held in contact with the metal surfaces. The region of the semi-solidified slurry where there is no oxide film has good wettability. Therefore, the end of the workpiece is wetted and closely contacted by the semi-solidified slurry, which is then solidified into a solidified mass. The solidified mass and the workpiece are firmly joined to each other. Stated otherwise, it is possible to produce a joined article having an insert-molded region of excellent joining strength even from metal materials of different alloy types.

According to the fourth embodiment of the present invention, there is provided a method of manufacturing a joined article by deforming a semi-solidified slurry placed in a mold assembly by stamping to insert-mold an end of a workpiece and then solidifying the semi-solidified slurry, comprising:

causing the end of the workpiece to abut against the semi-solidified slurry, pressing the end relatively against the semi-solidified slurry to cause the end to break through an oxide film on a surface of the semi-solidified slurry and then embedding the end in the semi-solidified slurry.

When the above steps are carried out, since the oxide film on the surface of the semi-solidified slurry is broken by the end of the workpiece, the end is embedded in a region of the semi-solidified slurry where there is no oxide film. When the semi-solidified slurry slides relatively to the workpiece while being pressed against the workpiece, the friction breaks the oxide film on the workpiece. In the region where the end of the workpiece is embedded, the workpiece with its metal surface exposed when the oxide film on the surface is broken confronts and contacts the semi-solidified slurry whose metal surface is exposed when the oxide film is removed from the surface thereof.

Through the above steps, the end of the workpiece whose metal surface is exposed by being embedded in the semi-solidified slurry is wetted and closely contacted by the exposed metal of the semi-solidified slurry. When the semi-solidified slurry which has wetted and closely contacted the end of the workpiece is solidified into a solidified mass, the solidified mass and the workpiece are firmly joined to each other, and thus a joined article having an insert-molded region of excellent joining strength can be obtained.

To form such an insert-molded region, for example, the end of the workpiece may be disposed vertically between lower and upper end portions of the semi-solidified slurry, and then the semi-solidified slurry may be stamped.

In either case, the workpiece may be pressed to shape. Thus, it is possible to produce a joined article of prescribed shape easily, simply, and efficiently.

According to a fifth embodiment of the present invention, there is provided a method of manufacturing a joined article by joining a semi-solidified slurry and a workpiece which are placed in a mold assembly to each other, comprising the steps of:

before or after the workpiece is placed in the mold assembly, bringing the workpiece to a temperature at which a metal element contained in the semi-solidified slurry can be diffused in the workpiece and a metal element contained in the workpiece can be diffused in the semi-solidified slurry; and

molding the semi-solidified slurry placed, together with the workpiece, in the mold assembly, and causing the semi-solidified slurry to slide on at least one end face of the workpiece.

On the end surface of the workpiece on which the semi-solidified slurry has slid, a thin oxide film of about 10 nm is broken. While the semi-solidified slurry is sliding along the end face of the workpiece, an oxide film that is present on the surface of the semi-solidified slurry is also broken. According to the present invention, the workpiece with its metal surface exposed when the oxide film on the surface is broken confronts and contacts the semi-solidified slurry whose metal surface is exposed when the oxide film is removed from the surface thereof.

The semi-solidified slurry whose oxide film is broken exhibits good wettability with respect to the region of the workpiece where no oxide film is present, i.e., metal. The semi-solidified slurry thus wets and closely contacts the workpiece, and is then solidified into a solidified mass. The solidified mass and the workpiece are firmly joined to each other.

A constituent element, e.g., Si, of the semi-solidified slurry is diffused in the workpiece, because the temperature of the workpiece has reached a level at which the metal element contained in the semi-solidified slurry can be diffused in the workpiece. At the same time, a constituent element, e.g., Mg, of the workpiece is diffused in the semi-solidified slurry or a solidified mass thereof.

According to the present invention, therefore, the workpiece and the solidified mass of the semi-solidified slurry are joined to each other by diffusion joining. Consequently, a joined article having a joint region of excellent joining strength can be produced.

If the semi-solidified slurry is made of an aluminum alloy containing Si as a major additive element, then the temperature of the workpiece may be set to 395° C. Owing thereto, Si contained in the semi-solidified slurry can be diffused sufficiently in the workpiece.

The semi-solidified slurry should preferably slide over a distance of 10 mm or greater. If the semi-solidified slurry slides over a distance smaller than 10 mm, the oxide film on the surface of the workpiece may not be broken sufficiently.

In order to increase the temperature of the workpiece, the workpiece may be kept in contact with the semi-solidified slurry. Specifically, the temperature of the workpiece is increased by heat transferred from the semi-solidified slurry.

Alternatively, heat may be transferred from the mold assembly to the workpiece. More specifically, the mold assembly may be sufficiently preheated before a stamping process is performed. Alternatively, the workpiece may be preheated outside of the mold assembly, and thereafter may be placed in the mold assembly.

According to a sixth embodiment of the present invention, there is provided a method of manufacturing a joined article of a workpiece which is partly or wholly previously placed in a mold assembly and a solidified mass of a molten metal poured in the mold assembly, comprising:

controlling vibration applying means to apply vibrations to the workpiece when the temperature of a contact region of the molten metal which is held in contact with the workpiece is equal to or higher than a liquidus temperature, and to stop applying vibrations when the temperature drops below the liquidus temperature.

In order to prevent vibrations from being applied to the molten metal in a coexisting solid-liquid phase, the vibration applying means may be shut down immediately before the temperature of the contact region drops below the liquidus.

If vibrations are applied to the molten metal in a solid phase, then cavities are formed because the solid phase and the liquid phase of a non-contact region are agitated into an agitated solid-liquid phase. According to the present invention, since vibrations are applied only when the contact region is in a liquid phase, an agitated solid-liquid phase is prevented from occurring, and hence cavities are prevented from being formed.

By applying vibrations as described above, the oxide films on both the molten metal and the workpiece are broken. The molten metal with its oxide film broken exhibits good wettability. Since the oxide film of the workpiece is also broken, the molten metal and the workpiece well wet and closely contact each other. The workpiece and the solidified mass are joined with good joining strength due to such a synergistic action.

If the temperature difference between the molten metal and the workpiece is large, the contact region is deprived of heat by the workpiece immediately after the molten metal has been brought into contact with the workpiece to form the contact region. The temperature of the contact region is quickly lowered below the liquidus temperature. As a result, the contact region is solidified. When a new molten metal is accumulated on the contact region, the contact region is melted again by the heat transferred from the new molten metal.

In such a case, before the contact region is solidified and after the contact region is re-melted, vibrations should preferably be applied to the molten metal. Specifically, the vibrations may be applied to the workpiece while the contact region is kept in a liquid phase immediately after the molten metal is brought into contact with the workpiece to form the contact region, and while the contact region that has been solidified by being deprived of heat by the workpiece is brought back into a liquid phase by heat transferred from a non-contact region of the molten metal which is held out of contact with the workpiece.

It is thus possible to easily produce a joined article which is free of cavities and which exhibits a sufficient joining strength.

The vibrations should preferably be applied to the workpiece at a frequency of 100 Hz or lower. Ultrasonic vibration suffers shortcomings in that there is a transmission loss and an ultrasonic vibrator tends to have a poor shock resistance. These shortcomings are less liable to occur if a vibration applying device for applying vibrations in a low frequency range is used.

Vibrations may be applied to a workpiece by rotating the workpiece, depending on the shape of the workpiece.

### BRIEF DESCRIPTION OF DRAWINGS

FIG. 1 is a schematic overall sectional plan view of an insert-molded article manufactured by a method of manufacturing an insert-molded article according to an embodiment of the present invention;

FIG. 2 is an enlarged fragmentary vertical cross-sectional view of the insert-molded article shown in FIG. 1;

FIG. 3 is a schematic vertical cross-sectional view of a front side of a mold of a mold apparatus;

FIG. 4 is a schematic vertical cross-sectional view of a rear side of the mold of the mold apparatus;

FIG. 5 is a schematic overall plan view of a die which provides the mold apparatus shown in FIG. 3;

FIG. 6 is a schematic vertical cross-sectional view of the front side of the mold of the mold apparatus shown in FIG. 3 which has been clamped;

FIG. 7 is a schematic vertical cross-sectional view of the rear side of the mold of the mold apparatus shown in FIG. 3 which has been clamped;

FIG. 8 is a schematic fragmentary vertical cross-sectional view of a mold of a mold apparatus;

FIG. 9 is a schematic fragmentary vertical cross-sectional view of the mold at the time only a first punch of the mold apparatus shown in FIG. 8 is lowered;

FIG. 10 is a schematic fragmentary vertical cross-sectional view of the mold at the time a second punch is lowered, so that the mold apparatus is clamped, from the state shown in FIG. 9;

FIG. 11 is an enlarged plan view of a portion of the mold which is in the state shown in FIG. 10;

FIG. 12 is an enlarged plan view of a portion of the mold where a restriction is not formed;

FIG. 13 is a table showing cross-sectional area reduction ratios provided by restrictions and joining strengths of joined regions of joined articles;

FIG. 14 is a schematic fragmentary sectional front elevational view of an apparatus for manufacturing a joined article (stamping apparatus) according to a first example of a third embodiment of the present invention;

FIG. 15 is a schematic fragmentary sectional front elevational view showing the manner in which a workpiece pressing mold of the stamping apparatus shown in FIG. 14 abuts against a workpiece;

FIG. 16 is a schematic fragmentary sectional front elevational view showing the manner in which the workpiece is pressed by the workpiece pressing mold and shaped by a shaping protrusion of a fixed die;

FIG. 17 is a schematic fragmentary sectional front elevational view showing the manner in which a semi-solidified slurry placed on the workpiece is pressed by a slurry pressing mold and shaped complementarily to the shape of the lower end face of the slurry pressing mold;

FIG. 18 is a schematic fragmentary sectional front elevational view of an apparatus for manufacturing a joined article (stamping apparatus) according to a second example of the third embodiment of the present invention;

FIG. 19 is a schematic fragmentary sectional front elevational view showing the manner in which a slurry outflow preventing member of the stamping apparatus shown in FIG. 18 abuts against a workpiece;

FIG. 20 is a schematic fragmentary sectional front elevational view showing the manner in which a semi-solidified slurry placed on the workpiece is pressed by a slurry pressing mold and shaped complementarily to the shape of the lower end face of the slurry pressing mold;

FIG. 21 is a schematic fragmentary sectional front elevational view showing the manner in which the slurry pressing mold is spaced from a molded body;

FIG. 22 is a schematic fragmentary sectional front elevational view showing the manner in which a workpiece pressing mold of the stamping apparatus shown in FIG. 18 abuts against the workpiece;

FIG. 23 is a schematic fragmentary sectional front elevational view showing the manner in which the workpiece is pressed by the workpiece pressing mold and shaped by a shaping protrusion of a fixed die;

FIG. 24 is a schematic overall vertical cross-sectional view of an automobile passenger compartment door as a joined article according to a fourth embodiment of the present invention; FIG. 25 is a cross-sectional view taken along line XXV-XXV of FIG. 24;

FIG. 26 is a schematic vertical cross-sectional view of a mold apparatus for manufacturing the automobile passenger compartment door shown in FIG. 24;

FIG. 27 is a schematic vertical cross-sectional view showing the manner in which a workpiece is shaped into a second door frame member by the mold apparatus shown in FIG. 26;

FIG. 28 is a schematic vertical cross-sectional view showing the manner in which a semi-solidified slurry starts to flow after the state shown in FIG. 27;

FIGS. 29A and 29B are enlarged fragmentary vertical cross-sectional views showing the degree of progress of the flowing of the slurry and the positional relationship between the semi-solidified slurry and an end of the second door frame member;

FIG. 30 is a schematic vertical cross-sectional view of the mold apparatus, showing the manner in which the semi-solidified slurry is shaped into a first joint member;

FIG. 31 is a schematic vertical cross-sectional view of the mold apparatus, showing the manner in which the mold apparatus is opened, exposing the automobile passenger compartment door;

FIG. 32 is a schematic overall vertical cross-sectional view of an automobile passenger compartment door as a joined article produced by a manufacturing method according to a fifth embodiment of the present invention;

FIG. 33 is a cross-sectional view taken along line XXXIII-XXXIII of FIG. 32;

FIG. 34 is an SEM photographic representation showing the manner in which an element Si contained in a joint member of the automobile passenger compartment door is diffused into a second door frame member thereof to form a diffusion junction;

FIG. 35 is a schematic vertical cross-sectional view of a mold apparatus for manufacturing the automobile passenger compartment door shown in FIG. 32;

FIG. 36 is a schematic vertical cross-sectional view showing the manner in which a workpiece is shaped into a second door frame member by the mold apparatus shown in FIG. 35;

FIG. 37 is a schematic vertical cross-sectional view showing the manner in which a semi-solidified slurry starts to flow after the state shown in FIG. 36;

FIGS. 38A and 38B are enlarged fragmentary vertical cross-sectional views showing the degree of progress of the flowing of the slurry and the positional relationship between the semi-solidified slurry and an end of the second door frame member;

FIG. 39 is a schematic vertical cross-sectional view of the mold apparatus, showing the manner in which the semi-solidified slurry is shaped into a first joint member;

FIG. 40 is a schematic vertical cross-sectional view of the mold apparatus, showing the manner in which the mold apparatus is opened, exposing the automobile passenger compartment door;

FIG. 41 is a graph showing degrees of joining achieved by a stamping process carried out at various different temperatures of the semi-solidified slurry and various different temperatures of the workpiece (the second door frame member);

FIG. 42 is a graph showing the relationship between temperatures of the workpiece (the second door frame member) and joint efficiencies in the stamping process;

FIG. 43 is a schematic vertical cross-sectional view showing the manner in which a semi-solidified slurry is placed on the upper end face of a workpiece placed in another mold apparatus;

FIG. 44 is a schematic vertical cross-sectional view showing the manner in which the semi-solidified slurry is molded after the state shown in FIG. 43;

FIG. 45 is a schematic vertical cross-sectional view of a mold assembly for carrying out a method of manufacturing a joined article according to a sixth embodiment of the present invention;

FIG. 46 is a graph showing how the temperature of a workpiece changes as the temperature of a poured molten metal changes;

FIG. 47 is a graph showing how the temperature of the poured molten metal changes;

FIG. 48 is a table showing the timings at which vibrations are applied to a workpiece and joined states; and

FIG. 49 is a schematic overall cross-sectional view of a wheel as a joined article manufactured by a method of manufacturing a joined article according to a sixth embodiment of the present invention.

### DESCRIPTION OF EMBODIMENTS

Preferred embodiments of the present invention will be described in detail below with reference to the accompanying drawings.

First, a first embodiment for performing a stamping process will be described below.

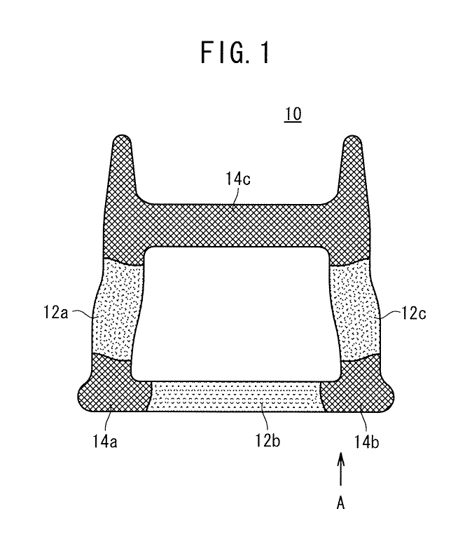

FIG. 1 is a schematic overall sectional plan view of an insert-molded article 10 as a joined article. The insert-molded article 10 has three hollow metal tubes 12a through 12c each filled with a sand core and joint members 14a through 14c each interposed between adjacent two of the hollow metal tubes 12a through 12c, and is used as a sub-frame of an automobile body.

The joint members 14a through 14c join ends of the hollow metal tubes 12a, 12b, ends of the hollow metal tubes 12b, 12c, and ends of the hollow metal tubes 12a, 12c, respectively. According to the first embodiment, the hollow metal tubes 12a through 12c are made of a metal material of one type, and the joint members 14a through 14c are made of a metal material of one type and are of an alloy type different from the hollow metal tubes 12a through 12c. For example, the hollow metal tubes 12a through 12c and the joint members 14a through 14c are made of, but not limited to, aluminum alloys A5052, AC4CH (both according to JIS), respectively.

The hollow metal tubes 12a, 12c extend in directions substantially perpendicular to directions in which the hollow metal tube 12b extends, and are disposed substantially parallel to each other. Therefore, the joint member 14c which joins the ends of the hollow metal tubes 12a, 12c is much longer than the remaining joint members 14a, 14b. The joint member 14c may hereinafter be also referred to as a bridge member 14c.

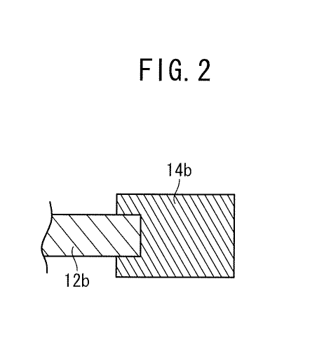

FIG. 2 is a vertical cross-sectional view as viewed from the direction indicated by the arrow A in FIG. 1. As can be seen from FIG. 2, the end of the hollow metal tube 12b is embedded in the joint member 14b. The embedding is achieved by insert molding, as described later. Although not shown, the ends of the hollow metal tubes 12a, 12b are also insert-molded in the joint member 14a, and similarly, the end of the hollow metal tube 12c is insert-molded in the joint member 14b. The other ends of the hollow metal tubes 12a, 12c are insert-molded in horizontal portions of the joint member 14c. As will be understood from the foregoing, in the insert-molded article 10, either one of the hollow metal tubes 12a through 12c is interposed between adjacent two of the joint members 14a through 14c.

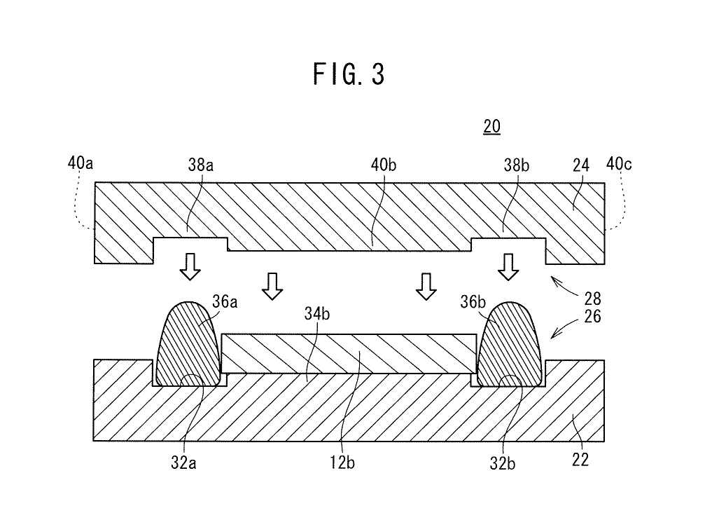

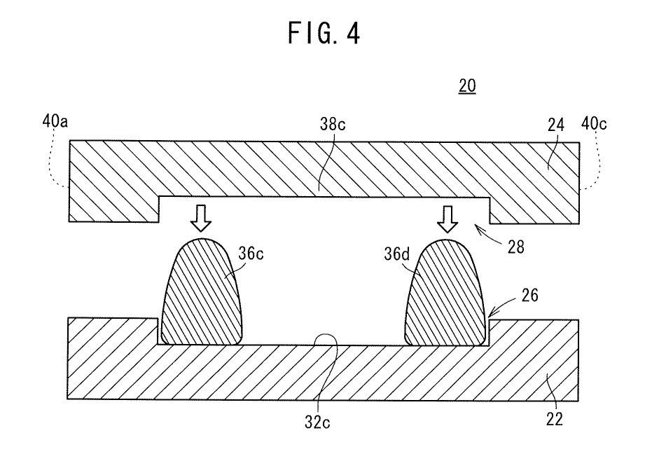

The insert-molded article 10 can be produced by a mold apparatus 20 whose front and rear sides are illustrated in respective schematic vertical cross-sectional views shown in FIGS. 3 and 4.

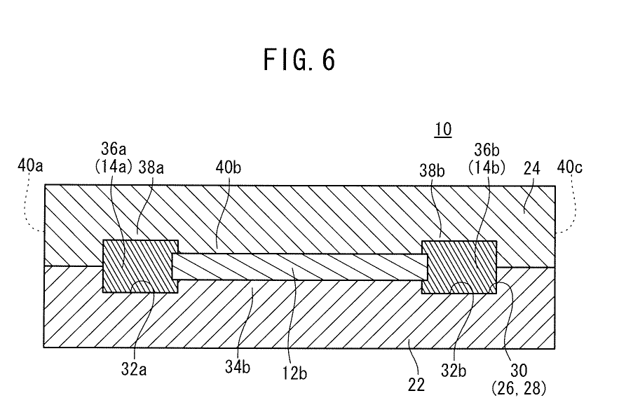

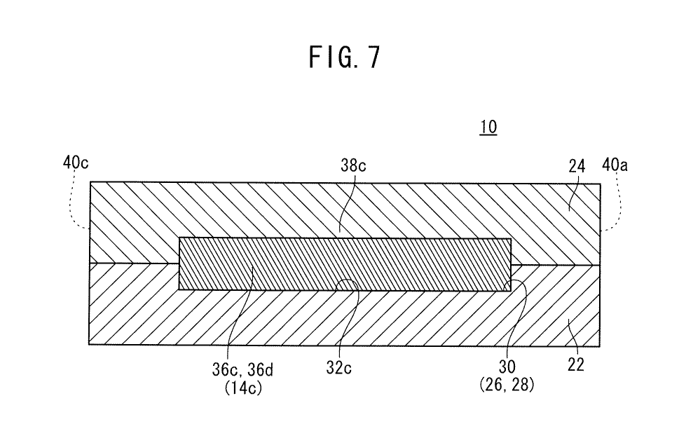

The mold apparatus 20 has a die 22 and a punch 24 as a mold. As shown in FIGS. 3 through 5, the die 22 and the punch 24 have respective recesses 26, 28 defined therein. When the die 22 and the punch 24 are clamped together, the spaces in the recesses 26, 28 are combined into a cavity 30 having a shape complementary to the shape of the insert-molded article 10 (see FIGS. 6 and 7).

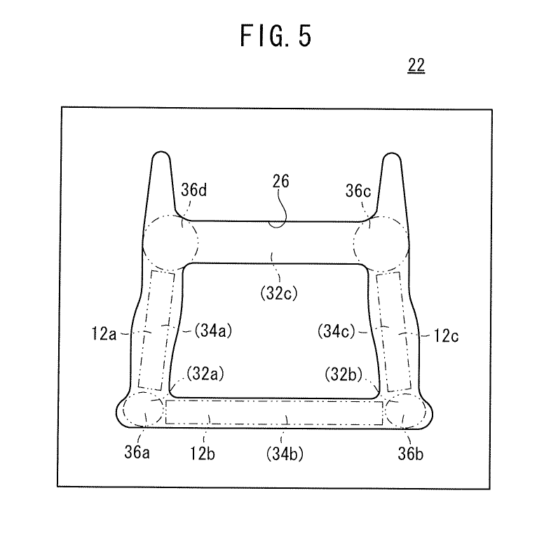

As shown in FIGS. 3 through 5, the die 22 has depressions 32a through 32c defined in prescribed regions thereof which provide the recess 26 and also has protrusive rests 34a through 34c each disposed between adjacent two of the depressions 32a through 32c. Substantially-conical semi-solidified slurries 36a through 36d are placed in the depressions 32a through 32c, respectively, and the hollow metal tubes 12a through 12c are placed on the rests 34a through 34c, respectively. As shown in FIG. 5, either one of the hollow metal tubes 12a through 12c is interposed between adjacent two of the semi-solidified slurries 36a through 36d. In FIG. 5, general locations where the semi-solidified slurries 36a through 36d and the hollow metal tubes 12a through 12c are placed are indicated by imaginary lines.

The punch 24 (see FIGS. 3 and 4) can be moved toward and away from the die 22 by a lifting and lowering mechanism, not shown. When the lifting and lowering mechanism moves the punch 24 toward the die 22, the punch 24 and the die 22 are clamped together, forming the cavity 30 (see FIGS. 6 and 7).

The punch 24 (see FIGS. 3 and 4) has slurry pressers 38a through 38c for pressing the semi-solidified slurries 36a through 36d. Of these slurry pressers 38a through 38c, the slurry pressers 38a, 38b press the semi-solidified slurries 36a, 36b, respectively, and the remaining slurry presser 38c presses the two semi-solidified slurries 36c, 36d simultaneously (see FIG. 4).

The punch 24 also has workpiece seals 40a through 40c for sealing the hollow metal tubes 12a through 12c (see FIG. 3). The workpiece seals 40a through 40c individually seal the hollow metal tubes 12a through 12c, respectively, and also prevent the semi-solidified slurries from flowing into the hollow metal tubes 12a through 12c.

A method of manufacturing the insert-molded article (joined article) 10 according to the first embodiment is carried out by the mold apparatus 20 thus constructed, as follows:

First, the hollow metal tubes 12a through 12c are placed respectively on the rests 34a through 34c, after which the semi-solidified slurries 36a through 36d are placed respectively in the depressions 32a through 32c. Alternatively, the semi-solidified slurries 36a through 36d may first be placed respectively in the depressions 32a through 32c, and then the hollow metal tubes 12a through 12c may be placed respectively on the rests 34a through 34c.

As described above, hollow metal tubes made of A5052, for example, may be selected as the hollow metal tubes 12a through 12c, and semi-solidified slurries made of AC4CH, for example, may be selected as the semi-solidified slurries 36a through 36c. The semi-solidified slurries 36a through 36d have on their surfaces a passivation oxide film which is formed when the surfaces are oxidized by oxygen in the atmosphere.

Then, the lifting and lowering mechanism is actuated to lower the punch 24. As the punch 24 is lowered, the slurry pressers 38a through 38c are brought into contact with the semi-solidified slurries 36a through 36d, applying a pressing force to the semi-solidified slurries 36a through 36d. As a result, the semi-solidified slurries 36a through 36d are compressed and start to flow. Since either one of the hollow metal tubes 12a through 12c is interposed between adjacent two of the semi-solidified slurries 36a through 36d, the semi-solidified slurries 36a through 36d flow toward the nearby ends of the hollow metal tubes 12a through 12c.

As the punch 24 is further lowered, the hollow metal tubes 12a through 12c are sealed by the workpiece seals 40a through 40c. In some cases, when the hollow metal tubes 12a through 12c are sealed by the workpiece seals 40a through 40c, the hollow metal tubes 12a through 12c may be shaped complementarily to the shapes of the workpiece seals 40a through 40c and the protrusive rests (the cavity 30).

When the punch 24 is lowered and the die 22 and the punch 24 are clamped together, the cavity 30 is formed (see FIGS. 6 and 7). As shown in FIG. 6, the semi-solidified slurry 36a surrounds the respective ends of the hollow metal tubes 12a, 12b, and the semi-solidified slurry 36b surrounds the other end of the hollow metal tube 12b and the end of the hollow metal tube 12c. Similarly, the semi-solidified slurries 36c, 36d surround the other ends of the hollow metal tubes 12a, 12c.

When the semi-solidified slurries 36a through 36d surround the ends of the hollow metal tubes 12a through 12c, the semi-solidified slurries 36a through 36d are prevented from flowing by the respective ends of the hollow metal tubes 12a through 12c. Therefore, the flow resistance of the semi-solidified slurries 36a through 36d increases.

As the flow resistance of the semi-solidified slurries 36a through 36d increases, the semi-solidified slurries 36a through 36d press the respective ends of the hollow metal tubes 12a through 12c with an increased pressing force. Accordingly, frictional forces between the semi-solidified slurries 36a through 36d and the respective ends of the hollow metal tubes 12a through 12c increase, whereupon the oxide film on the surfaces of the semi-solidified slurries 36a through 36d is broken by the increased frictional forces.

Stated otherwise, according to the first embodiment, the surface layer is broken by the frictional resistance which is applied from the respective ends of the hollow metal tubes 12a through 12c to the semi-solidified slurries 36a through 36d, thereby allowing internal slurries to flow out. Since the internal slurries are not oxidized, they are highly wet with respect to the other metal materials.

The slurries with good wettability are brought into contact with the respective ends of the hollow metal tubes 12a through 12c, i.e., the respective ends of the hollow metal tubes 12a through 12c are wetted by and held in close contact with the slurries. The slurries are then cooled and solidified into the joint members 14a, 14b. It is thus possible to join the respective ends of the hollow metal tubes 12a through 12c and the joint members 14a, 14b to each other while preventing an oxide film from being formed between the ends and the slurries, and the insert-molded article 10 is produced as a joined article.

At the same time, the compressed and shaped semi-solidified slurries 36c, 36d are joined to each other and cooled and solidified into the bridge member 14c. For the reasons described above, the bridge member 14c and the hollow metal tubes 12a, 12c are joined to each other with an increased strength.

With the insert-molded article 10 thus produced, adjacent two of the hollow metal tubes 12a through 12c and either one of the joint members 14a through 14c interposed therebetween are joined to each other with an increased strength because, as can be seen from the foregoing, an oxide film is prevented from being interposed between the hollow metal tubes 12a through 12c and the joint members 14a through 14c.

According to the first embodiment, as described above, the semi-solidified slurries 36a through 36d are caused to flow into surrounding relation to the respective ends of the hollow metal tubes 12a through 12c, thereby increasing the flow resistance of the semi-solidified slurries 36a through 36d to break the oxide film on the surfaces of the semi-solidified slurries 36a through 36d. Consequently, it is possible to firmly join metal materials of different alloy types.

In as much as the semi-solidified slurries 36a through 36d are used, a mold filling failure which would otherwise be caused when a molten metal in a coexisting solid-liquid phase is injection-molded is prevented from occurring. Therefore, the insert-molded article 10, even if it is a large in size, can efficiently be manufactured.

According to the first embodiment, the hollow metal tubes 12a through 12c are not shaped. However, depending on the shape of the insert-molded article 10, the hollow metal tubes 12a through 12c may be shaped at the same time that the semi-solidified slurries are compressed and molded.

A hollow metal tube may also be interposed between the semi-solidified slurries 36c, 36d, etc.

The semi-solidified slurries 36a through 36d are interposed between the hollow metal tubes 12a through 12c. However, the semi-solidified slurries 36a through 36d may be placed on the hollow metal tubes 12a through 12c, and then the mold apparatus may be clamped thereby to cause the semi-solidified slurries 36a through 36d to flow from the hollow metal tubes 12a through 12c to insert-molding locations.

In the first embodiment, furthermore, the four semi-solidified slurries 36a through 36d are employed. However, the number of semi-solidified slurries may be selected depending on the shape of the insert-molded article, and even one semi-solidified slurry is enough in some cases.

If a plurality of semi-solidified slurries are employed, then they may be made of metals of different alloy types.

In the first embodiment, moreover, the mold for producing a sub-frame is illustrated. However, the mold is not limited to the illustrated structure. The workpieces (insert-molded members) that are insert-molded by the semi-solidified slurries are not limited to the hollow metal tubes, but may be various shaped members such as solid columnar members, castings, etc.

A second embodiment will be described below. In the second embodiment, a stamping process is also performed.

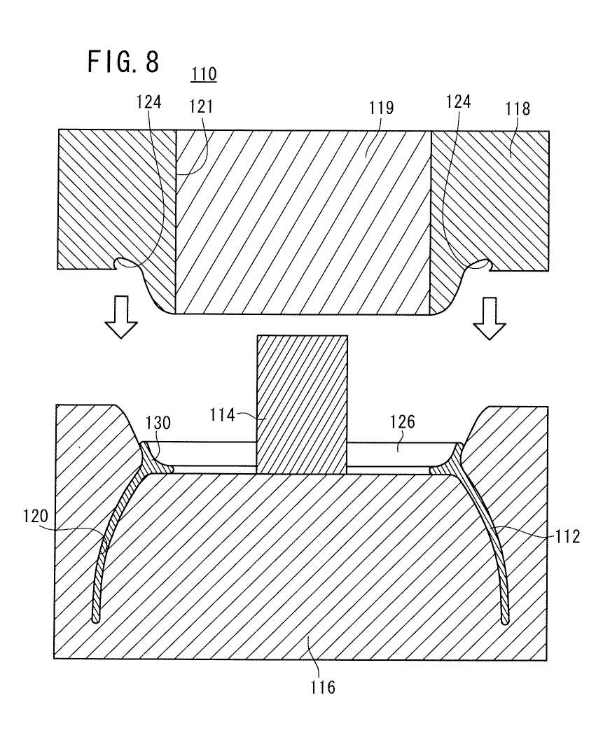

FIG. 8 is a schematic fragmentary vertical cross-sectional view of a mold apparatus 110 for performing a stamping process. The mold apparatus 110 serves to produce a wheel as a joined article. In FIG. 8, the reference characters 112, 114 represent a rim as a workpiece and a semi-solidified slurry as raw material of a disk, respectively. In the second embodiment, the rim 112 and the semi-solidified slurry 114 are metal materials of different alloy types.

The mold apparatus 110 has a die 116, a first punch 118, and a second punch 119 which serve as a mold. The die 116 has an annular insertion slot 120 defined therein, and the rim 112 is mostly inserted in the annular insertion slot 120, with only an upper end portion thereof being exposed. The semi-solidified slurry 114 which is approximately of a cylindrical shape is placed on a prescribed portion of the die 116 which is spaced from the annular insertion slot 120.

The first punch 118 has an insertion hole 121 defined substantially centrally therein. The second punch 119 is inserted in the insertion hole 121 at a position where the first punch 118 and the second punch 119 are spaced farthest away from the die 116. In other words, the first punch 118 is surrounded by the second punch 119.

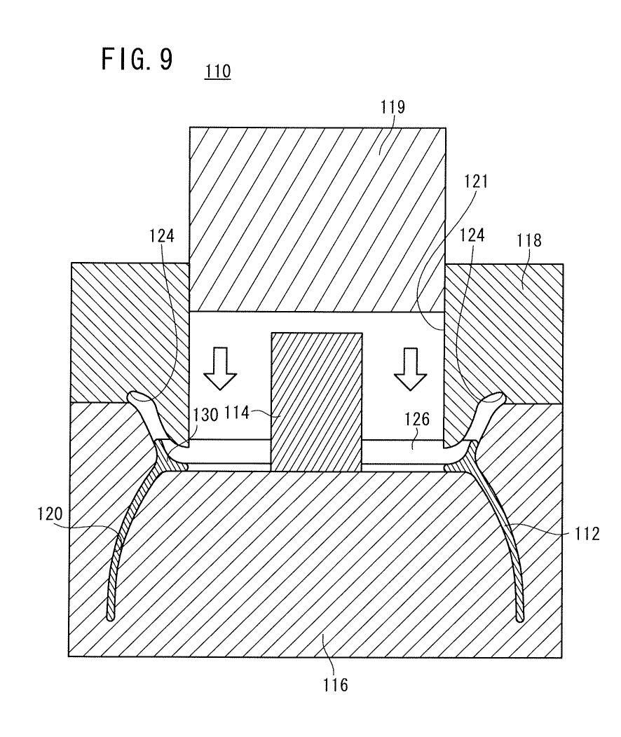

The first punch 118 and the second punch 119 can individually be moved toward and away from the die 116 by respective lifting and lowering mechanisms, not shown. For example, as shown in FIG. 9, while the second punch 119 is being held at rest, the first punch 118 is lowered toward the die 116.

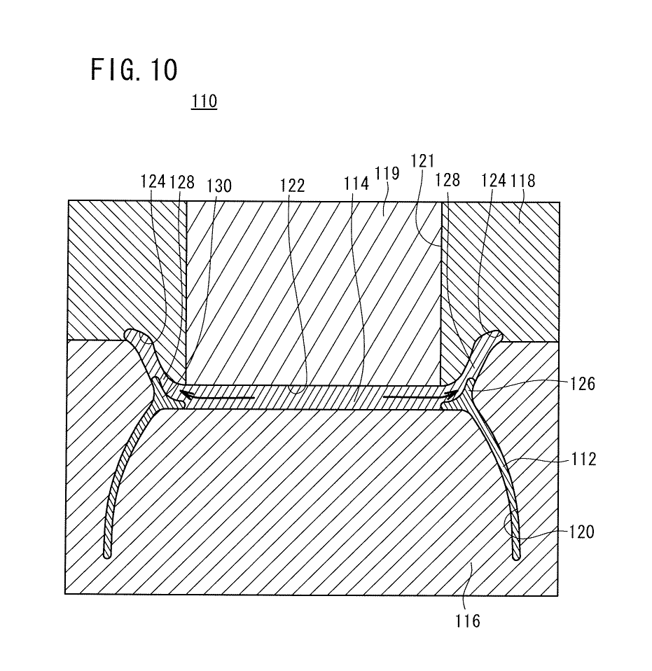

Thereafter, the second punch 119 is lowered most closely to the die 116, whereupon they are clamped together, forming a cavity 122 (see FIG. 10). The first punch 118 has a recess 124 defined therein as part of the cavity 122.

The upper end portion of the rim 112 which projects out of the annular insertion slot 120 includes an annular ridge 126 (see FIG. 8) extending toward the first punch 118 and the second punch 119. The semi-solidified slurry 114 is placed at a position which is substantially aligned with the center of the annular ridge 126.

As described later, when the die 116, the first punch 118, and the second punch 119 are clamped together, the annular ridge 126 forms a restriction 128 (see FIG. 10) in the cavity 122. When the semi-solidified slurry 114 flows through the restriction 128, its flow resistance increases due to the restriction 128.

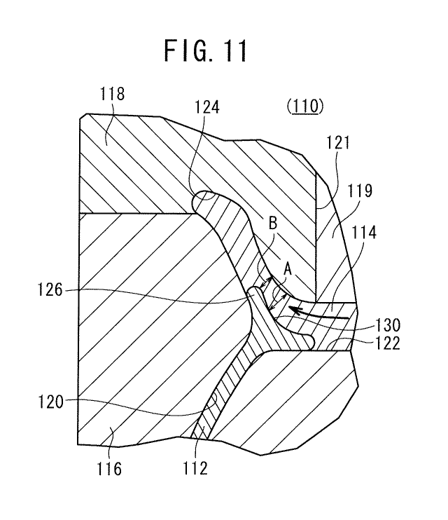

Using A, B shown in FIG. 11, the cross-sectional area reduction ratio of the restriction 128 is expressed by the following equation (1):

Cross-sectional area reduction ratio [%]=100×(A−B)/A (1)

where A represents the cross-sectional area of the cavity 122 at a starting end portion 130 of the annular ridge 126, and B represents the minimum cross-sectional area of the restriction 128.

If the cross-sectional area reduction ratio is excessively small, then it is not effective enough to increase the flow resistance of the semi-solidified slurry 114. On the other hand, if the cross-sectional area reduction ratio is excessively large, then it will not be easy to cause the semi-solidified slurry 114 to flow. To avoid these difficulties, it is preferable to set the cross-sectional area reduction ratio to a value in the range from 10 to 40%. If the height of the annular ridge 126 is selected such that the cross-sectional area reduction ratio is set to a value in the range from 10 to 40%, then an appropriate flow resistance is applied to the semi-solidified slurry 114.

A stamping process (a method of manufacturing a joined article) according to the second embodiment which is carried out by the mold apparatus 110 thus constructed will be described below.

First, the rim 112 is inserted into the annular insertion slot 120 in the die 116, and thereafter the semi-solidified slurry 114 is placed on the prescribed portion of the die 116. The semi-solidified slurry 114 is a slurry in a coexisting solid-liquid phase which has been manufactured by another mold apparatus. Therefore, there is little chance for the semi-solidified slurry 114 that is placed on the die 116 to flow.

The semi-solidified slurry 114 is of a high temperature as can be understood from the fact that it is not solidified inside. Therefore, the surface of the semi-solidified slurry 114 is oxidized by oxygen in the atmosphere, producing an oxide film as a passivation film.

Then, as shown in FIG. 9, the lifting and lowering mechanism is actuated to lower the first punch 118. When the lowering of the first punch 118 is finished, the second punch 119 is lowered into pressing contact with the semi-solidified slurry 114.

As the second punch 119 is lowered into pressing contact with the semi-solidified slurry 114, the second punch 119 applies a pressing force to the semi-solidified slurry 114. As a result, the semi-solidified slurry 114 is compressed and then starts to flow. Since the semi-solidified slurry 114 is positioned substantially centrally within the annular ridge 126, the semi-solidified slurry 114 flows toward the annular ridge 126.

When the second punch 119 is lowered by its maximum stroke, and the die 116, the first punch 118 and the second punch 119 are clamped together, they form the cavity 122, as shown in FIG. 10. The semi-solidified slurry 114 rises along the annular ridge 126, then filling the recess 124.

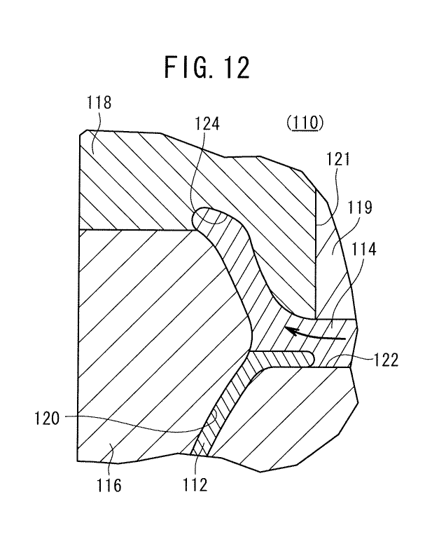

The annular ridge 126 is not required to deform the semi-solidified slurry 114 into a disk shape. As shown in FIG. 12, an ordinary rim 112 is free of the annular ridge 126. With the ordinary rim 112, the semi-solidified slurry 114 reaches the recess 124 with its flow resistance remaining essentially unchanged.

According to the second embodiment, however, as shown in FIGS. 8 through 11, the rim 112 includes the annular ridge 126 in its upper end portion, providing a narrow channel through which the semi-solidified slurry 114 flows. In other words, the restriction 128 is defined by the annular ridge 126 which extends in a direction to obstruct the flow of the semi-solidified slurry 114. Consequently, when the semi-solidified slurry 114 flows through the restriction 128 toward the recess 124, the flow resistance of the semi-solidified slurry 114 increases.

As the flow resistance of the semi-solidified slurry 114 increases, the pressing force which the semi-solidified slurry 114 applies to press the annular ridge 126 increases. Therefore, the frictional force between the semi-solidified slurry 114 and the annular ridge 126 increases, and then breaks the oxide film on the surface of the semi-solidified slurry 114.

Stated otherwise, according to the second embodiment, immediately before the semi-solidified slurry 114 passes through the restriction 128, it undergoes the frictional resistance from the annular ridge 126 and then the surface of the semi-solidified slurry 114 is broken, thereby causing the inside slurry to flow out. The slurry that flows out is not oxidized, and has good wettability with respect to other metal materials.

The slurry with good wettability is brought into contact with an upstream portion of the annular ridge 126 with respect to the direction in which the semi-solidified slurry 114 flows, i.e., the starting end portion 130. Thus, the starting end portion 130 is wetted and closely contacted by the slurry. Then, the slurry is cooled and solidified, whereupon it is joined to the starting end portion 130 while preventing an oxide film from being formed between the starting end portion 130 and the slurry, thereby producing a wheel as a joined article.

In the wheel thus produced, the rim 112 and the disk are joined to each other with an increased strength, because, as can be understood from the foregoing, an oxide film is prevented from being formed between the starting end portion 130 of the annular ridge 126 and the slurry, or in other words, between the rim 112 and the disk.

According to the second embodiment, as described above, since the flow resistance of the semi-solidified slurry 114 is increased by providing the restriction 128 in the cavity 122 thereby to break the oxide film on the surface of the semi-solidified slurry 114, it is possible to firmly join metal materials of different alloy types.

In the second embodiment, the restriction 128 is provided by the annular ridge 126 on the rim 112 (workpiece). However, a restriction 128 may be provided by an annular ridge 126 on the first punch 118 or on the second punch 119, for example.

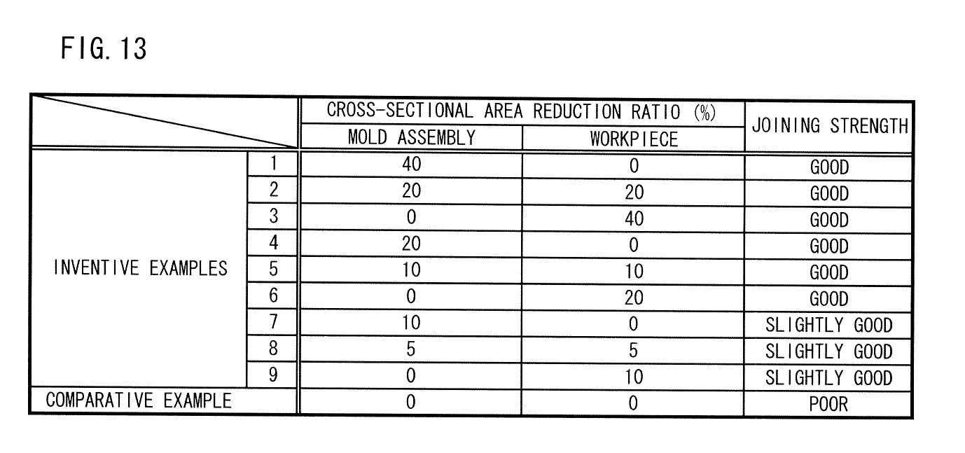

FIG. 13 is a table showing the relationship between cross-sectional area reduction ratios in a case where a disk formed of a semi-solidified slurry 114 of aluminum alloy AC4CH (JIS) having a solid-phase ratio of 50% is joined to a rim 112 of aluminum alloy A5182 (JIS), and joining strengths between the rim 112 and the disk. In FIG. 13, the cross-sectional area reduction ratio of the mold means the cross-sectional area reduction ratio provided by the restriction 128 in the mold, and the cross-sectional area reduction ratio of the workpiece means the cross-sectional area reduction ratio provided by the restriction 128 on the rim 112. FIG. 13 also shows Comparative Example in which either the mold or the rim 112 is free of the restriction 128.

The joining strength was evaluated by a tensile test. Specifically, five samples were made for each of Inventive Examples 1 through 9 and Comparative Example, and the disk and the rim 112 joined together in each sample were pulled apart in opposite directions. When the rim 112 was broken in all five samples, the group of the five samples was judged as “good”. When the disk and the rim 112 were separated at the joined region in all five samples, it was judged as “poor”. When the rim 112 was broken in some samples while the disk and the rim 112 were separated in the other samples, it was judged as “slightly good”.

As can be seen from FIG. 13, the sample groups of Inventive Examples 1 through 9 were not judged as “poor” at all, and the sample group of Comparative Example was judged “poor”. It will be clear from these results that the restriction 128 provided in the cavity 122 increases the joining strength.

In the second embodiment, the mold for producing a wheel is illustrated. However, the mold is not limited to the illustrated structure.

A third embodiment will be described below. In the third embodiment, a stamping process is also performed as with the above embodiments.

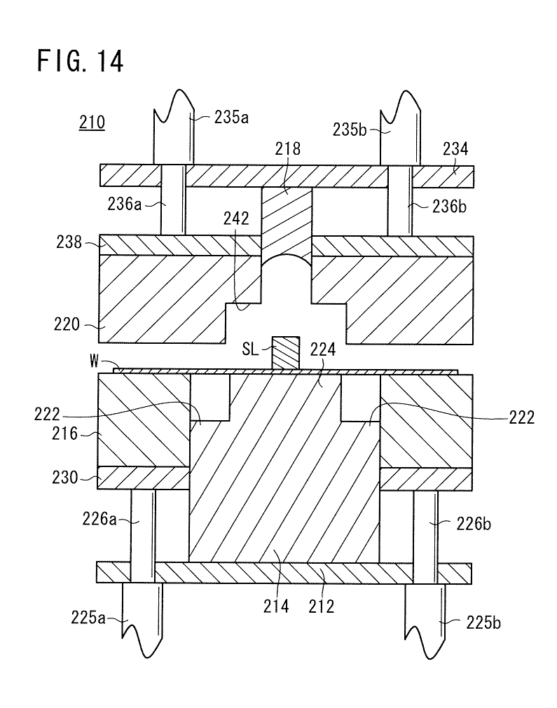

FIG. 14 is a schematic fragmentary sectional front elevational view of a stamping apparatus 210 according to a first example of a third embodiment of the present invention. The stamping apparatus 210 is an apparatus for manufacturing a joined article. The stamping apparatus 210 has a base plate 212, a fixed die 214 positioned on and fixed to the base plate 212, workpiece support molds 216 (first mold) disposed in surrounding relation to the fixed die 214, a slurry pressing mold 218 (second mold) for pressing a semi-solidified slurry SL, and workpiece pressing molds 220 (third mold) for pressing a workpiece W. As described later, the workpiece pressing mold 220 doubles as a slurry outflow preventing member for blocking the semi-solidified slurry SL which flows. In the first example, the workpiece W and the semi-solidified slurry SL are made of, but not limited to, aluminum alloys A5052, AC4CH (both according to JIS), respectively.

The fixed die 214 mounted on the base plate 212, which is substantially in the form of a flat plate, has a shaping protrusion 224 projecting from shoulders 222 on the distal end portion thereof. As described later, the workpiece W is shaped complementarily to the shaping protrusion 224.

The workpiece support molds 216, with the fixed die 214 disposed therebetween, are vertically displaceable by respective rods 226a, 226b of cylinder devices 225a, 225b. Specifically, as the rods 226a, 226b are extended or retracted, the workpiece support molds 216 that are fixed to the distal ends of the rods 226a, 226b by seats 230 are elevated or lowered.

The slurry pressing mold 218 and the workpiece pressing molds 220 are mounted on a support plate 234 which lies in confronting relation to the base plate 212. The slurry pressing mold 218 is disposed at a position sandwiched by the workpiece pressing molds 220, and is positioned on and fixed to the support plate 234.

The slurry pressing mold 218 has a curved lower end face. Therefore, the semi-solidified slurry SL is shaped complementarily to the shape of the curved lower end face of the slurry pressing mold 218.

Cylinder devices 235a, 235b have respective rods 236a, 236b extending downwardly from the support plate 234, and a seat 238 is mounted on the lower ends of the rods 236a, 236b. The workpiece pressing molds 220 are supported on the seat 238 in facing relation to the workpiece W.

Pressing forces of the cylinder devices 235a, 235b are set to a level greater than pressing forces of the cylinder devices 225a, 225b.

The workpiece pressing molds 220 have steps 242 which are shaped complementarily to the shaping protrusion 224. In other words, the steps 242 have edges substantially confronting the edges of the shaping protrusion 224.

The support plate 234 is vertically displaceable by a lifting and lowering device (e.g., a hydraulic cylinder or the like), not shown. Stated otherwise, the support plate 234 is vertically movable toward and away from the base plate 212.

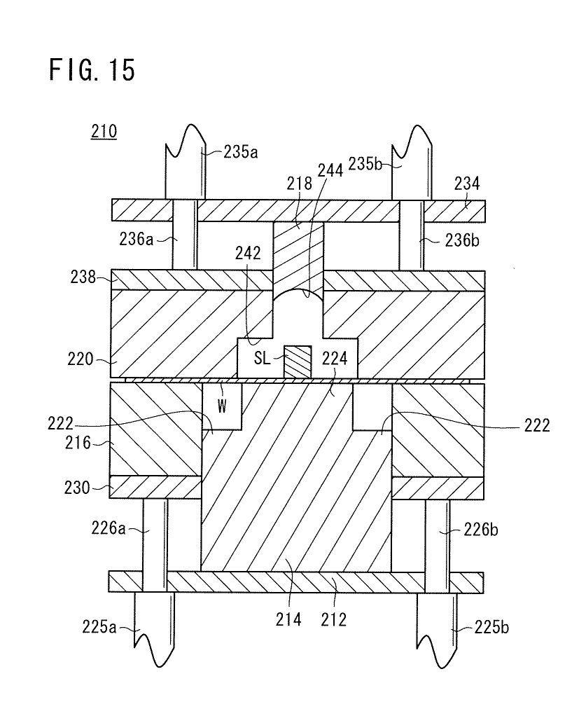

The semi-solidified slurry SL has dimensions that are set such that it is spaced from each of the workpiece pressing molds 220. When the stamping apparatus 210 has its mold assembly closed, the semi-solidified slurry SL is placed in a space 244 that is defined by the workpiece W, the workpiece pressing molds 220, and the slurry pressing mold 218, as shown in FIG. 15.

The stamping apparatus 210 according to the first example of the third embodiment is basically constructed as described above. Operation and advantages of the stamping apparatus 210 will be described below in relation to a stamping process (a method of manufacturing a joined article).

The stamping process is carried out by the stamping apparatus 210, as follows:

First, as shown in FIG. 14, the workpiece W, which is substantially in the form of a flat plate, is placed on the upper end faces of the workpiece support molds 216 such that the workpiece W has its end portions extending over the fixed die 214. The workpiece W is now supported on the workpiece support molds 216. At this time, all the rods 226a, 226b, 236a, 236b are placed in an extended state.

Then, the semi-solidified slurry SL is placed in a prescribed position on the upper end face of the workpiece W. The semi-solidified slurry SL is beforehand manufactured by another mold apparatus and taken out in a coexisting solid-liquid phase. Consequently, there is little chance for the semi-solidified slurry SL that is simply placed on the workpiece W to flow. The surface of the semi-solidified slurry SL is oxidized by oxygen in the atmosphere, producing an oxide film as a passivation film.

The lifting and lowering device, not shown, is actuated to lower the support plate 234 toward the base plate 212. Together with the support plate 234, the slurry pressing mold 218 and the workpiece pressing molds 220 are also lowered. As shown in FIG. 15, the workpiece pressing molds 220 are initially brought into abutment against the workpiece W. An upper end face of the workpiece W, sides of the workpiece pressing molds 220, and the curved lower end face of the slurry pressing mold 218 jointly define the space 244 therebetween, with the semi-solidified slurry SL placed in the space 244.

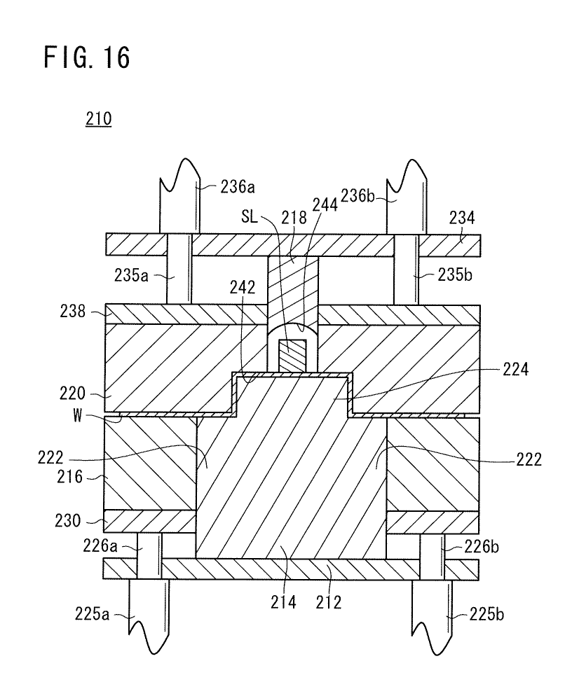

When the support plate 234 is further lowered, a middle portion of the workpiece W is pressed by the steps 242 of the workpiece pressing molds 220, as shown in FIG. 16. Under pressing forces from the workpiece pressing molds 220, the rods 226a, 226b are contracted because the pressing forces of the cylinder devices 235a, 235b are greater than the pressing forces of the cylinder devices 225a, 225b, as described above.

As the rods 226a, 226b are contracted, the workpiece support molds 216 are lowered toward the base plate 212 until the upper end faces of the workpiece support molds 216 lie flush with the shoulders 222 of the fixed die 214, whereupon the portion of the workpiece W which has been pressed by the steps 242 of the workpiece pressing molds 220 is shaped complementarily to the shape of the shaping protrusion 224 of the fixed die 214. The shaping of the workpiece W is now finished.

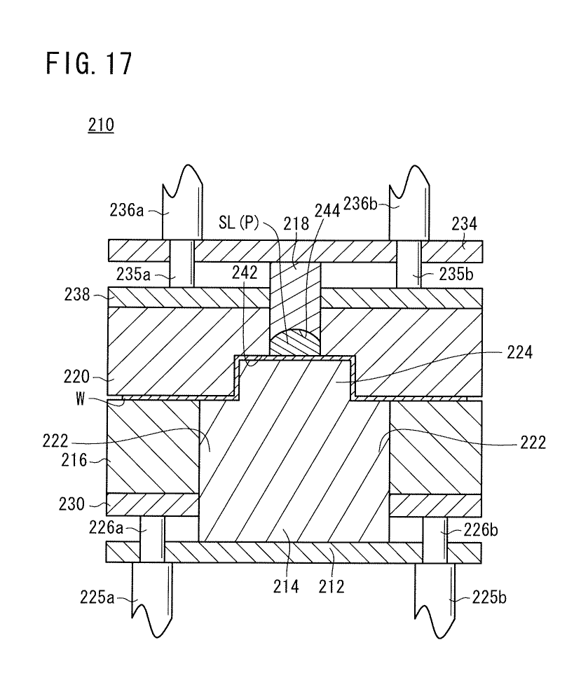

Thereafter, the support plate 234 is further lowered. The rods 236a, 236b start receiving reactive forces from the workpiece support molds 216, and, as a result, are contracted, as shown in FIG. 17.

The lower end face of the slurry pressing mold 218 presses the semi-solidified slurry SL. The pressed semi-solidified slurry SL then starts to flow radially from the pressed region thereof. The flowing semi-solidified slurry SL is eventually blocked by the sides of the workpiece pressing molds 220. Consequently, the semi-solidified slurry SL is prevented from flowing out of the space 244.

The semi-solidified slurry SL has a surface layer whose solid-phase ratio is higher than inside of the semi-solidified slurry SL. Therefore, the surface layer of the semi-solidified slurry SL is held in sliding contact with the workpiece W while being pressed against the workpiece W. Because the semi-solidified slurry SL is held in sliding contact with the workpiece W, the oxide film on the surface layer of the semi-solidified slurry SL is removed.

When the semi-solidified slurry SL flows, it spreads outwardly by being pressed by the slurry pressing mold 218, i.e., is diffused in sliding contact with the surface of the workpiece W while being compressed. As the semi-solidified slurry SL is thus compressed and spread, the surface layer (oxide film) of the semi-solidified slurry SL is broken and cracked, thereby causing the inside slurry to flow out through the cracks. The slurry that flows out is not oxidized, and has good wettability with respect to the workpiece W which is made of a metal material having a different alloy type.

According to the first example of the third embodiment, as described above, the slurry with good wettability is held in contact with the upper end face of the workpiece W. Thus, the workpiece W is well wetted and closely contacted by the slurry. Then, the slurry is cooled and solidified into a molded body P, producing a joined article due to mutual diffusion while the slurry is being cooled.

In the joined article thus produced, the workpiece W and the molded body P have a large joining strength. This is because the workpiece W and the slurry are joined to each other while preventing an oxide film from being formed between the workpiece W and the slurry, as can be understood from the foregoing, so that an oxide film is prevented from being interposed between the workpiece W and the molded body P.

According to the first embodiment, the workpiece W is shaped and the semi-solidified slurry SL is molded by the same stamping apparatus 210. Therefore, the joined article can efficiently be produced.

For opening the mold assembly, the lifting and lowering device may be lifted. The support plate 234 is elevated away from the base plate 212 to space the workpiece pressing molds 220 and the slurry pressing mold 218 from the fixed die 214 and the workpiece support molds 216. Then, the cylinder devices 225a, 225b, 235a, 235b are actuated to extend the rods 226a, 226b, 236a, 236b thereby to return the workpiece support molds 216 and the slurry pressing mold 218 to their original positions (see FIG. 14).

In the first example of the third embodiment, the workpiece W is initially shaped, and then the semi-solidified slurry SL is molded. Conversely, the workpiece W may be shaped after the semi-solidified slurry SL has been molded. Such a modification will be described below as a second example.

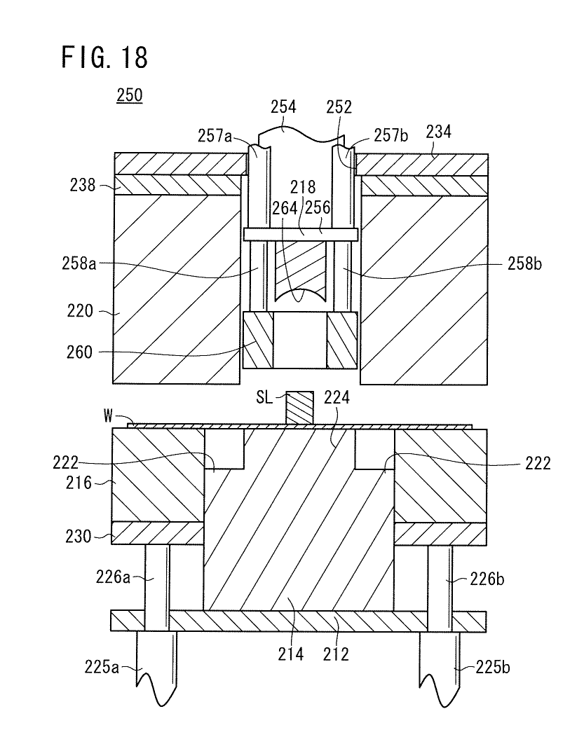

FIG. 18 is a schematic fragmentary sectional front elevational view of a stamping apparatus 250 according to a second example of the third embodiment of the present invention. The stamping apparatus 250 is also an apparatus for manufacturing a joined article. Those parts of the stamping apparatus 250 which are identical to those of the stamping apparatus 210 according to the first example of the third embodiment are denoted by identical reference characters, and will not be described in detail below.

The stamping apparatus 250 has a base plate 212, a fixed die 214, workpiece support molds 216 (first mold), a slurry pressing mold 218 (second mold) for pressing a semi-solidified slurry SL, and workpiece pressing molds 220 (third mold) for pressing a workpiece W. As with the stamping apparatus 210 according to the first embodiment, the workpiece support molds 216 are mounted on seats 230 supported by rods 226a, 226b of cylinder devices 225a, 225b.

The workpiece pressing molds 220 are supported on a support plate 234 having a through hole 252 defined therein. A rod 254 of a hydraulic cylinder, not shown, extends through the through hole 252. The slurry pressing mold 218 is supported on a seat 256 mounted on the lower end of the rod 254.

Cylinder devices 257a, 257b have respective rods 258a, 258b extending vertically downwardly and disposed around the slurry pressing mold 218 supported on the seat 256. A slurry outflow preventing member 260 which is substantially in the form of a hollow cylinder is mounted on the lower distal ends of the rods 258a, 258b.

Pressing forces of the cylinder devices 257a, 257b are set to a level smaller than pressing forces of the cylinder devices 225a, 225b.

The support plate 234 is vertically displaceable toward and away from the base plate 212 by a lifting and lowering device (e.g., a hydraulic cylinder or the like), not shown.

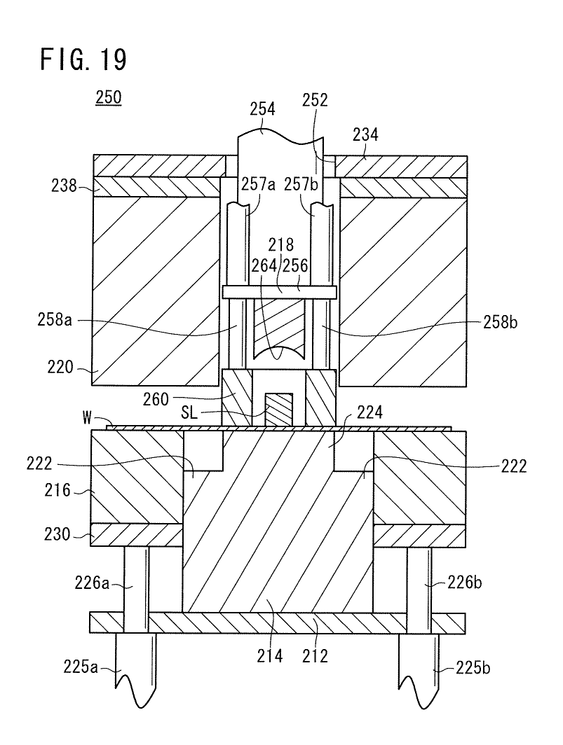

The semi-solidified slurry SL has dimensions that are set such that it is spaced from the slurry outflow preventing member 260. When the stamping apparatus 250 has its mold assembly closed, the semi-solidified slurry SL is placed in a space 264 that is defined by the workpiece W, the slurry outflow preventing member 260, and the slurry pressing mold 218, as shown in FIG. 19.

The stamping apparatus 250 according to the second example of the third embodiment is basically constructed as described above. Operation and advantages of the stamping apparatus 250 will be described below in relation to a stamping process (a method of manufacturing a joined article).

The stamping process is carried out by the stamping apparatus 250, as follows:

First, as shown in FIG. 18, the workpiece W, which is substantially in the form of a flat plate, is placed on the upper end faces of the workpiece support molds 216 such that the workpiece W has its end portions extending over the fixed die. The workpiece W is now supported on the workpiece support molds 216. At this time, all the rods 226a, 226b, 258a, 258b are placed in an extended state. Thereafter, a semi-solidified slurry SL with an oxide film present on a surface thereof is placed at a prescribed position on an upper end face of the workpiece W.

Then, the hydraulic cylinder, not shown, is actuated to advance the rod 254 vertically downwardly, causing the slurry pressing mold 218 and the slurry outflow preventing member 260 to descend toward the workpiece W. As a result, as shown in FIG. 19, the slurry outflow preventing member 260 is brought into abutment against the workpiece W. The upper end face of the workpiece W, inner walls of the slurry outflow preventing member 260, and the curved lower end face of the slurry pressing mold 218 jointly define the space 264 therebetween, with the semi-solidified slurry SL placed in the space 264.

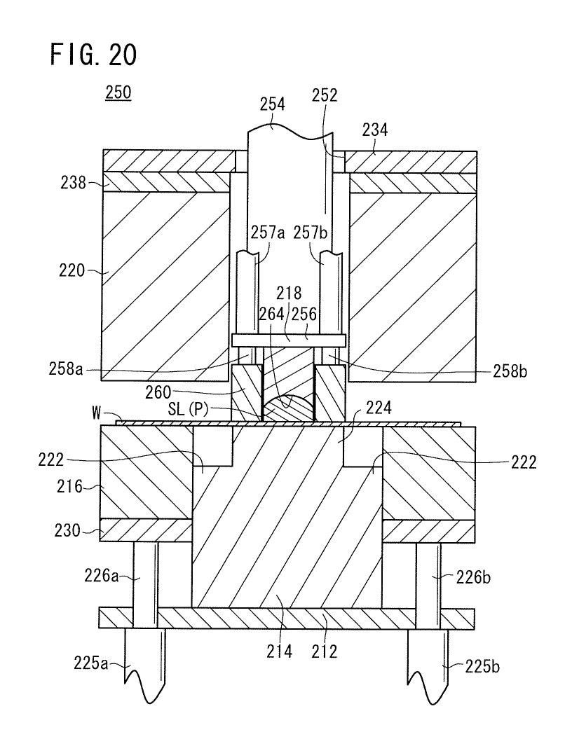

When the rod 254 is further advanced (lowered), as shown in FIG. 20, the rods 258a, 258b are initially contracted because the pressing forces of the cylinder devices 257a, 257b are smaller than the pressing forces of the cylinder devices 225a, 225b.

Substantially at the same time that the rods 258a, 258b are contracted, the lower end face of the slurry pressing mold 218 presses the semi-solidified slurry SL. The pressed semi-solidified slurry SL then starts to flow radially from the pressed region thereof, as in the first embodiment. At this time, the surface layer, whose solid-phase ratio is high, of the semi-solidified slurry SL is pressed against the workpiece W, whereupon the oxide film is removed. As the semi-solidified slurry SL flows while being compressed, the oxide film on the surface layer is broken, causing the inside slurry to flow out through the cracks produced in the broken oxide film.

According to the second example of the third embodiment, consequently, the slurry which is not oxidized and accordingly has good wettability is held in contact with the upper end face of the workpiece W. Thus, the workpiece W is well wetted and closely contacted by the slurry. Then, the slurry is cooled and solidified into a molded body P, thereby producing a joined article of good joining strength due to mutual diffusion while the slurry is flowing, with an oxide film being prevented from being interposed between the workpiece W and the molded body P.

The flowing semi-solidified slurry SL is eventually blocked by the inner walls of the slurry outflow preventing member 260. Consequently, the semi-solidified slurry SL is prevented from flowing out of the space 264.

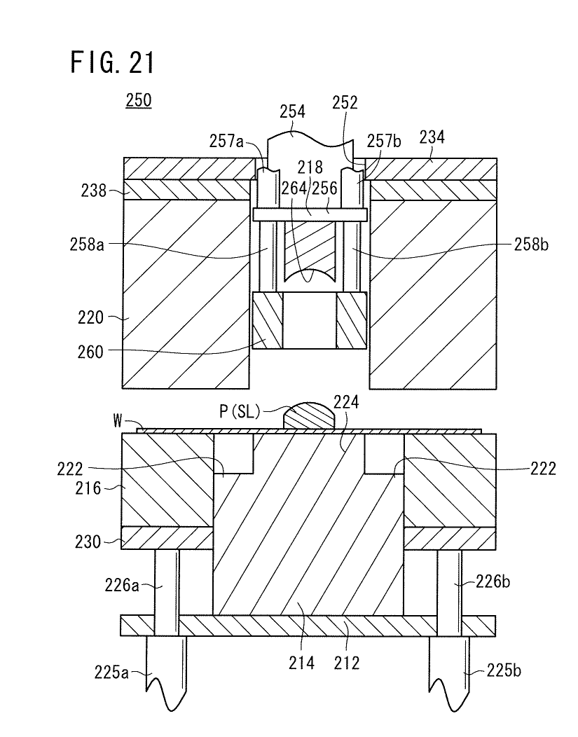

After the workpiece W and the molded body P (the semi-solidified slurry SL) are joined to each other, the workpiece W is shaped. Specifically, as shown in FIG. 21, the hydraulic cylinder is actuated to retract (lift) the rod 254 so as to move the slurry outflow preventing member 260 away from the molded body P. After the slurry outflow preventing member 260 is moved away from the molded body P, the cylinder devices 257a, 257b are actuated to extend the rods 258a, 258b to return the slurry outflow preventing member 260 to its original position.

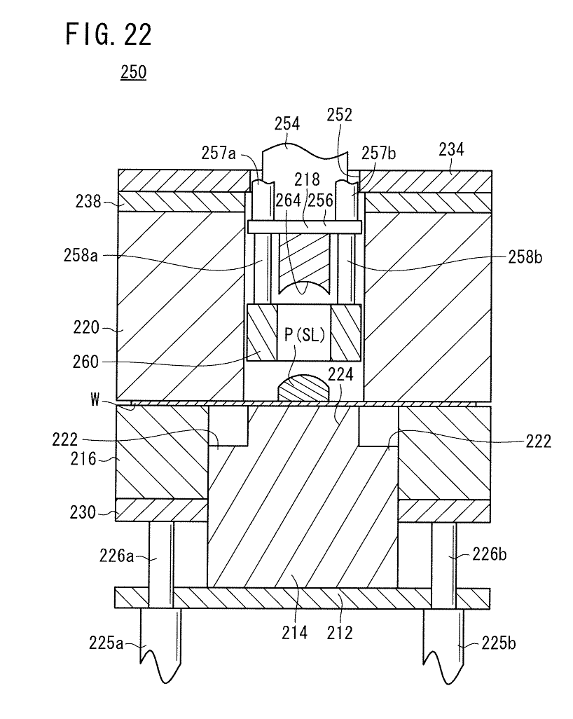

Then, the lifting and lowering device, not shown, is actuated to lower the support plate 234 toward the base plate 212. Upon the descent of the support plate 234, the workpiece pressing molds 220 are lowered into abutment against the workpiece W, as shown in FIG. 22.

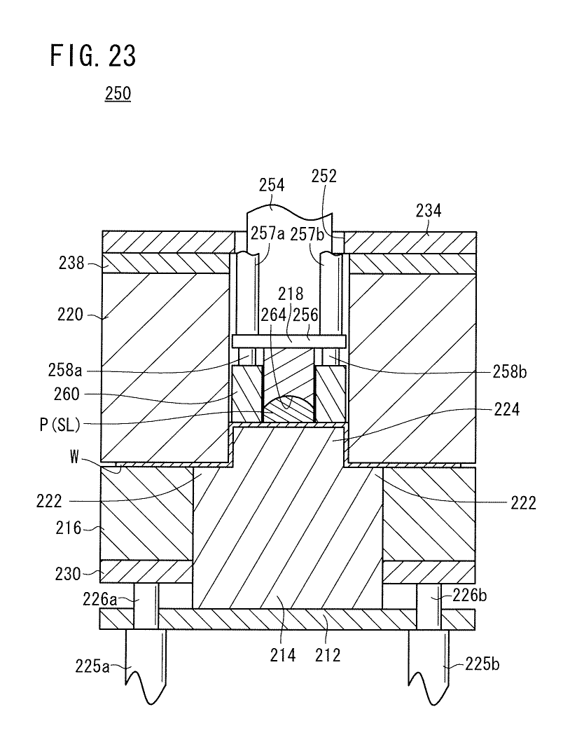

When the support plate 234 is further lowered, as shown in FIG. 23, the end portions of the workpiece W are pressed by the workpiece pressing molds 220. Under the pressing forces from the workpiece pressing molds 220, the rods 226a, 226b are contracted. At the same time, the molded body P may be surrounded by the slurry outflow preventing member 260.

As the rods 226a, 226b are thus contracted, the workpiece support molds 216 are lowered toward the base plate 212. As a result, the curved protrusions 32a, 32b have their top faces lying flush with the shoulders 222 of the fixed die 214, and the end portions of the workpiece W which are pressed by the steps 242 of the workpiece pressing molds 220 are shaped complementarily to the shape of the shaping protrusion 224 of the fixed die 214. The shaping of the workpiece W is now finished.

According to the second example of the third embodiment, the workpiece W is shaped and the semi-solidified slurry SL is molded by the same stamping apparatus 250. Therefore, the joined article can efficiently be produced.

For opening the mold assembly, the lifting and lowering device and the rod 254 may be lifted. The support plate 234 is elevated away from the base plate 212, and the workpiece pressing molds 220 is accordingly moved away from the fixed die 214 and the workpiece support molds 216. Then, the cylinder devices 225a, 225b are actuated to extend the rods 226a, 226b thereby to return the workpiece support molds 216 to their original positions (see FIG. 18).

In the first example and second example, the semi-solidified slurry SL is placed in a substantially central region of the workpiece W. However, the semi-solidified slurry SL is not limited to being placed in that region, but may be placed on an end portion of the workpiece W, for example. In this case, a portion of the semi-solidified slurry SL may project from the workpiece W.

In both the first example and second example, the stamping apparatus 210, 250 include the workpiece pressing molds 220 for shaping the workpiece W. However, a stamping apparatus may exclude the workpiece pressing molds 220.

The cylinder devices 225a, 225b, 235a, 235b, 257a, 257b may be replaced with coil springs and rods extensible and contractible under the resiliency of the coil springs.

A fourth embodiment will be described below. In the fourth embodiment, a stamping process is also performed.

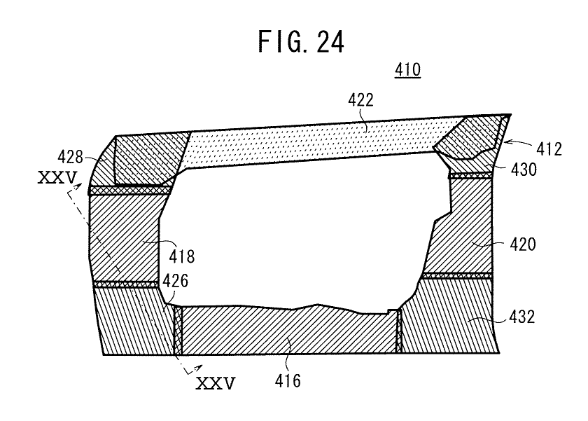

FIG. 24 is a schematic overall vertical cross-sectional view of an automobile passenger compartment door 410 as a joined article according to a fourth embodiment of the present invention. The automobile passenger compartment door 410 has a door body 412.

The door body 412 comprises a first door frame member 416 which is horizontally elongate, a second door frame member 418 and a third door frame member 420 which are disposed at the respective ends of the first door frame member 416 and which extend substantially perpendicularly to the longitudinal directions of the first door frame member 416, and a window frame member 422 which cooperates with the first door frame member 416, the second door frame member 418 and the third door frame member 420 to make up a substantially rectangular shape.

An end of the first door frame member 416 and an end of the second door frame member 418 are connected to each other by a first joint member 426. The other end of the second door frame member 418 and an end of the window frame member 422 are connected to each other by a second joint member 428. The remaining other end of the window frame member 422 is connected to an end of the third door frame member 420 by a third joint member 430. The other end of the third door frame member 420 is connected to the other end of the first door frame member 416 by a fourth joint member 432.

In the fourth embodiment, the first door frame member 416, the second door frame member 418, the third door frame member 420, and the window frame member 422 are made of an aluminum alloy of one type. The first joint member 426, the second joint member 428, the third joint member 430, and the fourth joint member 432 are made of an aluminum alloy of one type which is of a different alloy type from the first door frame member 416, the second door frame member 418, the third door frame member 420, and the window frame member 422. The material of the first door frame member 416, the second door frame member 418, the third door frame member 420, and the window frame member 422 and the material of the first joint member 426, the second joint member 428, the third joint member 430, and the fourth joint member 432 may, for example, be A5182, AC4CH (both according to JIS), respectively, but are not limited to these alloys.

FIG. 25 is an enlarged cross-sectional view taken along line XXV-XXV of FIG. 24. As can be seen from FIG. 25, the end of the second door frame member 418 is embedded in the first joint member 426 and joined to the first joint member 426. As can be seen from FIG. 24, the end of the first door frame member 416 is also embedded in the first joint member 426 and joined to the first joint member 426.

As shown in FIG. 25, an oxide film 434 is present on the surface of the first joint member 426, and the second door frame member 418 breaks through the oxide film 434 and is embedded in the first joint member 426. Specifically, the second door frame member 418 is joined to the first joint member 426 at a region within the first joint member 426 where no oxide film 434 is present, or in other words, where the aluminum alloy as the material of the first joint member 426 is exposed.

An oxide film 436 is also present on the surface of the second door frame member 418 at a region which is exposed from the first joint member 426. No oxide film 436 is present at a region of the second door frame member 418 which is embedded in the first joint member 426. As described later, when a semi-solidified slurry for forming the first joint member 426 slides on the surface of the second door frame member 418, the sliding semi-solidified slurry breaks the oxide film 436.

Although not shown, the remaining end of the second door frame member 418 and the end of the window frame member 422 are insert-molded in the second joint member 428. Similarly, the other end of the window frame member 422 and the end of the third door frame member 420 are insert-molded in the third joint member 430. The other end of the third door frame member 420 and the other end of the first door frame member 416 are insert-molded in the fourth joint member 432.

In the joints, the members 418, 420, 422 break through the oxide films 434 on the surfaces of the joint members 426, 428, 430, 432 and are embedded therein, as with the joint shown in FIG. 25. The oxide films 434 on the surfaces of the members 418, 420, 422 are also broken.

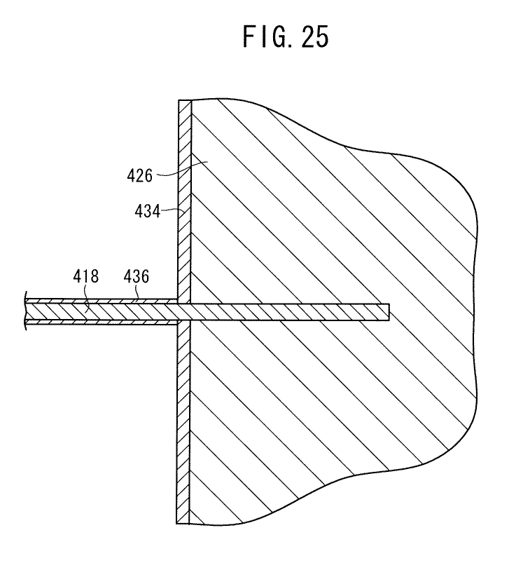

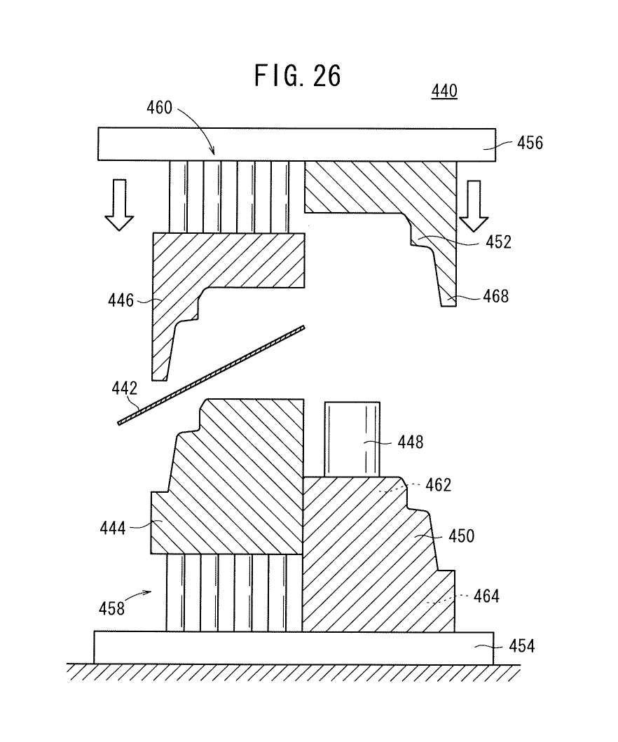

The automobile passenger compartment door 410 (joined article) is produced by a mold apparatus 440, a schematic vertical cross-sectional view of which is shown in FIG. 26. FIG. 26 shows a portion of the mold apparatus which shapes a door portion taken along line XXV-XXV of FIG. 24.

The mold apparatus 440 includes a first die 444 and a first punch 446 as a die assembly for shaping a workpiece 442 into the second door frame member 418, and a second die 450 and a second punch 452 for stamping a semi-solidified slurry 448 into the first joint member 426. The first die 444 and the second die 450 are mounted on a fixed plate 454, and the first punch 446 and the second punch 452 are mounted on a surface of a movable plate 456 which faces the fixed plate 454. The movable plate 456 is movable toward and away from the fixed plate 454.

The first die 444 is supported on the distal ends of a first rod train 458 which comprises the respective rods of a plurality of cylinders, not shown. When the cylinders are actuated in synchronism with each other to advance or retract the first rod train 458, the first die 444 is vertically displaced in unison with the first rod train 458.

The first punch 446 is supported on the distal ends of a second rod train 460 which comprises the respective rods of a plurality of cylinders, not shown. When the cylinders are actuated in synchronism with each other to advance or retract the second rod train 460, the second punch 452 is vertically displaced in unison with the second rod train 460.

The second die 450 is mounted on the fixed plate 454 adjacent to the first die 444. The semi-solidified slurry 448 is placed on a wide upper end face of the second die 450.

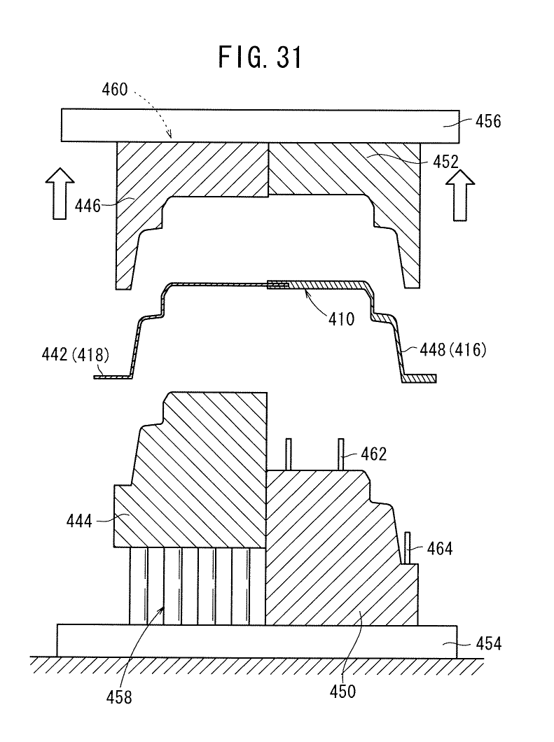

First knockout pins 462 and a second knockout pin 464 (see FIG. 31) are projectably and retractably embedded respectively in the upper end face and the upper surface of a right end portion of the second die shown in FIG. 26. When the first knockout pins 462 and the second knockout pin 464 project from the upper end face and the upper surface of the right end portion, the joined article is released from the mold apparatus.

The second punch 452 is a mold member for pressing the semi-solidified slurry 448. Specifically, the semi-solidified slurry 448 is pressed and compressed by the second punch 452, and then flows.

When a lifting and lowering mechanism, not shown, is actuated, the movable plate 456 is moved toward and away from the fixed plate 454. When the movable plate 456 is moved toward the fixed plate 454, the mold apparatus is clamped. When the movable plate 456 is moved away from the fixed plate 454, the mold apparatus is opened.

A method of manufacturing the joined article according to the fourth embodiment is carried out by the mold apparatus 440 thus constructed, as follows:

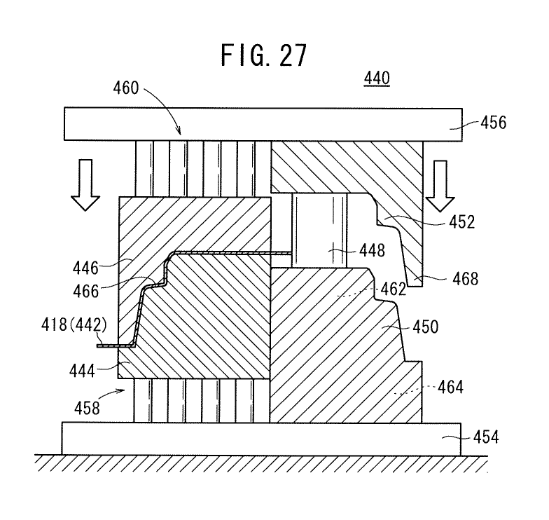

First, as shown in FIG. 26, the workpiece 442 is inserted between the first die 444 and the first punch 446. The semi-solidified slurry 448 is placed on the upper end face of the second die 450. The semi-solidified slurry 448 is put in a position that is spaced from the first die 444 by a prescribed distance, preferably 10 mm or greater. The workpiece 442 has an end disposed vertically between the upper and lower ends of the semi-solidified slurry (see FIG. 27).

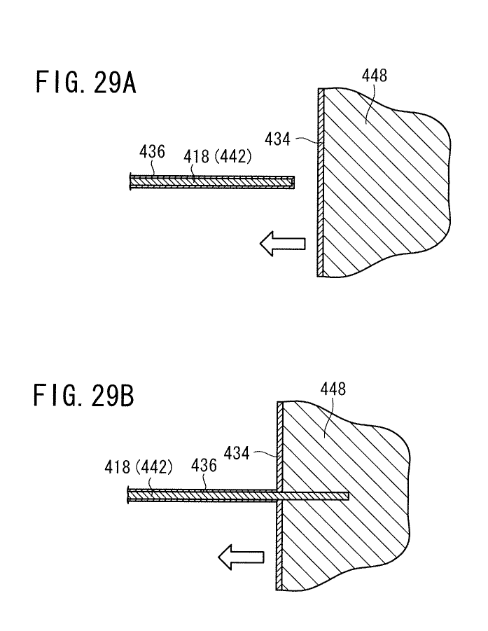

As described above, the workpiece 442 may be made of an aluminum alloy A5182, for example, and the semi-solidified slurry 448 may be made of an aluminum alloy AC4CH which is of a different alloy type from A5182. Oxide films 434, 436 (see FIGS. 25 and 29) as passivation films are present on the surfaces of the semi-solidified slurry 448 and the workpiece 442, the oxide films 434, 436 being formed when the surfaces are oxidized by oxygen in the atmosphere.

Then, as shown in FIG. 27, the lifting and lowering mechanism is actuated to lower the first punch 446 and the second punch 452 together with the movable plate 456. When the first punch 446 and the second punch 452 are lowered, the first die 444 and the second punch 452 jointly define a first cavity 466. The workpiece 442 is shaped complementarily to the first cavity 466, i.e., is shaped into a form corresponding to the second door frame member 418. The end of the second door frame member 418 projects from the first cavity 466 so as to extend toward the semi-solidified slurry 448.

At this time, the semi-solidified slurry 448 is not compressed.

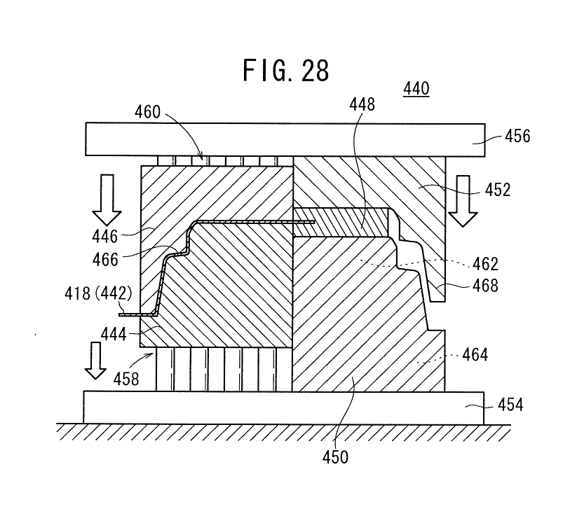

Then, as shown in FIG. 28, the lifting and lowering mechanism is actuated to lower the movable plate 456 further. The second punch 452 starts pressing the semi-solidified slurry 448, which is compressed and starts to flow. The second rod train 460 is synchronously retracted, thereby holding the first cavity 466 and the second door frame member 418 in position.

The portion of the semi-solidified slurry 448 which has flowed toward the first die 444 and the first punch 446 is initially spaced from the end of the second door frame member 418, as shown in FIG. 29A. As the semi-solidified slurry 448 flows on, it abuts against the end of the second door frame member 418. When the flowing of the semi-solidified slurry 448 progresses further, as shown in FIG. 29B, the end of the second door frame member 418 breaks through the oxide film 434 and is embedded in the semi-solidified slurry 448.

At this time, the semi-solidified slurry 448 slides along the opposite end faces of the second door frame member 418 while pressing the end of the second door frame member 418 under the pressing force applied through the second punch 452. The friction caused by the sliding movement breaks the oxide films 436 on the surfaces of the second door frame member 418. In other words, the oxide films 436 are removed from the surfaces of the second door frame member 418, thereby exposing metal surfaces thereof. In order to break the oxide films 436, the semi-solidified slurry 448 should preferably slide relatively on the second door frame member 418 by a distance of 10 mm or greater.

The oxide film 434 is present only on the surface of the semi-solidified slurry 448, and not within the semi-solidified slurry 448. The exposed metal surfaces within the semi-solidified slurry 448 have good wettability with respect to other metal materials, i.e., the second door frame member 418. The end of the second door frame member 418 which is surrounded by the semi-solidified slurry 448 with good wettability is wetted and closely contacted by the inside of the semi-solidified slurry 448 (see FIG. 28).

The end of the second door frame member 418 which is embedded in the semi-solidified slurry 448 also has its metal surfaces exposed. Therefore, the wettability of the semi-solidified slurry 448 with respect to the second door frame member 418 is further increased.

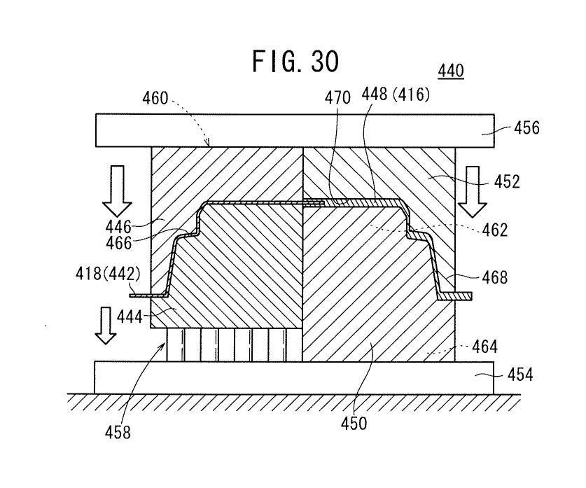

As shown in FIG. 30, when the movable plate 456 is further lowered, the semi-solidified slurry 448 is blocked by the first die 444 and the first punch 446, and a seal portion 468 of the second punch 452. More specifically, the semi-solidified slurry 448 is shaped complementarily to a second cavity 470 which is jointly defined by the first die 444, the first punch 446, the second die 450, and the second punch 452. At this time, the first rod train 458 is slightly retracted, lowering the first die 444. The movable plate 456 is thus easily lowered.

Then, the semi-solidified slurry 448 is cooled and solidified into the first joint member 426. The end of the second door frame member 418 is now connected to the first joint member 426 while avoiding the formation of a new oxide film between the end of the second door frame member 418 and the semi-solidified slurry 448.

Similarly, the first door frame member 416 and the third door frame member 420 are shaped in other areas in the mold apparatus 440. The first door frame member 416 and the third door frame member 420, together with the window frame member 422, are insert-molded by prescribed ones of the first joint member 426, the second joint member 428, the third joint member 430, and the fourth joint member 432. In this manner, the automobile passenger compartment door 410 is produced as a joined article wherein the ends of the members 416, 18, 20, 22 are joined by the joint members 426, 28, 30, 32.

Finally, as shown in FIG. 31, the lifting and lowering mechanism is actuated to lift the movable plate 456 to separate the first punch 446 and the second punch 452 from the first die 444 and the second die 450, thereby opening the mold apparatus. The first knockout pins 462 and the second knockout pin 464 are projected from the second die 450, releasing the automobile passenger compartment door 410.

In the automobile passenger compartment door 410 (joined article) thus produced, the ends of the members 416, 418, 420, 422 are joined to the joint members 426, 428, 430, 432 with a large joining strength because, as can be understood from the foregoing, the oxide films 434, 436 are prevented from being interposed between the ends of the members 416, 418, 420, 422 and the joint members 426, 428, 430, 432.

According to the fourth embodiment, as described above, the flowing semi-solidified slurry 448 is brought into abutment against the ends of the members 416, 418, 420, 422, which break through the oxide film 434 on the surface of the semi-solidified slurry 448 and are embedded in the semi-solidified slurry 448, i.e., in the region where the oxide film 434 is not present. In addition, the semi-solidified slurry 448 is caused to slide along the end faces of the members 416, 418, 420, 422 while pressing the end faces of the members 416, 418, 420, 422. The friction caused by the sliding movement breaks the oxide films 436 on the surfaces of the members 416, 418, 420, 422. Consequently, the members 416, 418, 420, 422 and the semi-solidified slurry 448 (the joint members 426, 428, 430, 432) which are made of metal materials of different alloy types can firmly be joined to each other.

In the fourth embodiment, the semi-solidified slurry 448 flows to cause the ends of the members 416, 418, 420, 422 to press the semi-solidified slurry 448. However, the members 416, 418, 420, 422 may be moved by cylinders or the like, for example, to embed the ends of the members 416, 418, 420, 422 in the semi-solidified slurry 448, after which the semi-solidified slurry 448 may be stamped. In this case, the members 416, 418, 420, 422 should also preferably be moved by a distance of 10 mm or greater.

In the fourth embodiment, the workpiece 442 is pressed into the second door frame member 418. However, the workpiece 442 may not be pressed, and only the semi-solidified slurry 448 may be stamped.

The joined article is not limited to the automobile passenger compartment door 410 in particular.

A fifth embodiment will be described below. In the fifth embodiment, a stamping process is also performed.

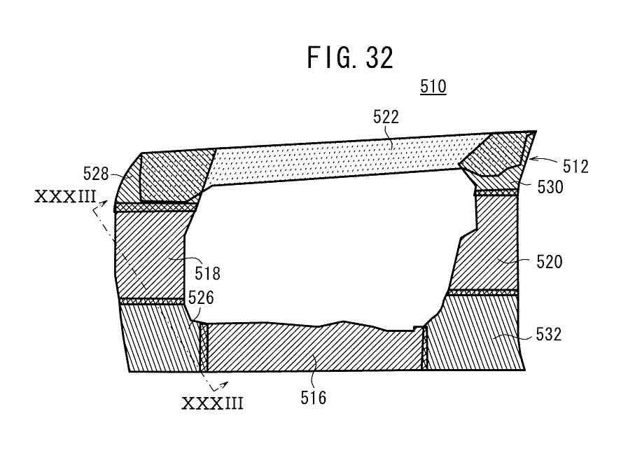

First, an automobile passenger compartment door 510 as a joined article produced by a stamping method (a method of manufacturing a joined article) according to the fifth embodiment will be described below with reference to FIG. 32. FIG. 32 is a schematic overall vertical cross-sectional view of the automobile passenger compartment door 510.

The automobile passenger compartment door 510 is made up of components which are essentially identical to those of the automobile passenger compartment door 410. Specifically, the automobile passenger compartment door 510 comprises a first door frame member 516 which is horizontally elongate, a second door frame member 518 and a third door frame member 520 extending substantially perpendicularly to the longitudinal directions of the first door frame member 516, and a window frame member 522 which cooperates with the first door frame member 516, the second door frame member 518 and the third door frame member 520 to make up a substantially rectangular shape.

An end of the first door frame member 516 and an end of the second door frame member 518 are connected to each other by a first joint member 526. The other end of the second door frame member 518 and an end of the window frame member 522 are connected to each other by a second joint member 528. The remaining other end of the window frame member 522 is connected to an end of the third door frame member 520 by a third joint member 530. The other end of the third door frame member 520 is connected to the other end of the first door frame member 516 by a fourth joint member 532.

In the fifth embodiment, as with the fourth embodiment, the first door frame member 516, the second door frame member 518, the third door frame member 520, and the window frame member 522 are made of an aluminum alloy of one type. The first joint member 526, the second joint member 528, the third joint member 530, and the fourth joint member 532 are made of an aluminum alloy of one type which is of a different alloy type from the first door frame member 516, the second door frame member 518, the third door frame member 520, and the window frame member 522. The material of the first door frame member 516, the second door frame member 518, the third door frame member 520, and the window frame member 522 and the material of the first joint member 526, the second joint member 528, the third joint member 530, and the fourth joint member 532 may, for example, be A5182, AC4CH (both according to JIS), respectively, but are not limited to these alloys.

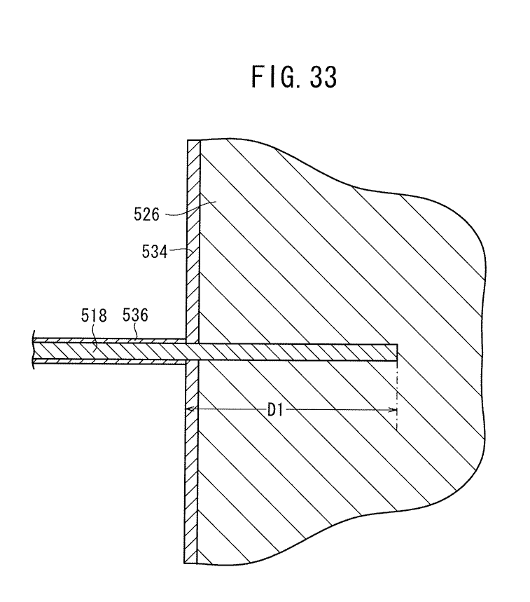

FIG. 33 is an enlarged cross-sectional view taken along line XXXIII-XXXIII of FIG. 32. The region shown corresponds to the region shown in FIG. 25.

As can be seen from FIG. 33, according to the fifth embodiment, as with the fourth embodiment, the end of the second door frame member 518 is embedded in the first joint member 526 and joined to the first joint member 526. The embedded end has a length D1 of about 15 mm. As can be seen from FIG. 32, the end of the first door frame member 516 is also embedded in the first joint member 526 and joined to the first joint member 526.

As shown in FIG. 33, an oxide film 534 is present on the surface of the first joint member 526, and the second door frame member 518 breaks through the oxide film 534 and is embedded in the first joint member 526. Specifically, the second door frame member 518 is joined to the first joint member 526 at a region in the first joint member 526 where no oxide film 534 is present, or in other words, where the aluminum alloy as the material of the first joint member 526 is exposed.

An oxide film 536 is present on the surface of the second door frame member 518 at a region which is exposed from the first joint member 526. No oxide film 536 is present at a region of the second door frame member 518 which is embedded in the first joint member 526. As described later, when a semi-solidified slurry for forming the first joint member 526 slides on the surface of the second door frame member 518, the sliding semi-solidified slurry breaks the oxide film 536.

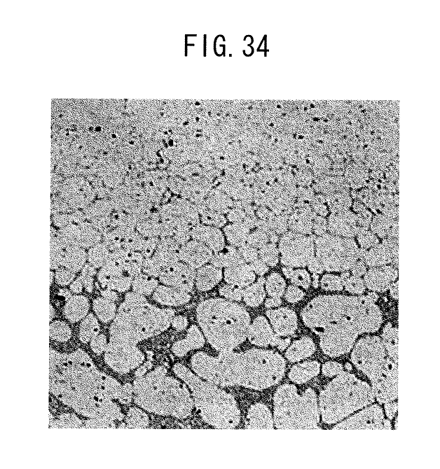

As shown in FIG. 34, in the joined region, A1 which is a metal element of the first joint member 526 is fused to the second door frame member 518. In other words, the second door frame member 518 and the first joint member 526 are joined to each other by diffusion joining.

Although not shown, the remaining end of the second door frame member 518 and the end of the window frame member 522 are insert-molded in the second joint member 528. Similarly, the other end of the window frame member 522 and the end of the third door frame member 520 are insert-molded in the third joint member 530. The other end of the third door frame member 520 and the other end of the first door frame member 516 are insert-molded in the fourth joint member 532.

In the joints, the members 518, 520, 522 break through the oxide films 534 on the surfaces of the joint members 526, 528, 530, 532 and are embedded therein, as with the joint shown in FIG. 33. Each of the embedded ends has a dimension of about 15 mm, as with the second door frame member 518 embedded in the first joint member 526. Within the joint members 526, 528, 530, 532 where no oxide film 534 is present, Si which is a major additive element of the joint members 526, 528, 530, 532 (AC4CH) is diffused into the members 518, 520, 522 (A5182), and Mg which is a major additive element of the members 518, 520, 522 (A5182) is diffused into the joint members 526, 528, 530, 532, providing diffusion joints.

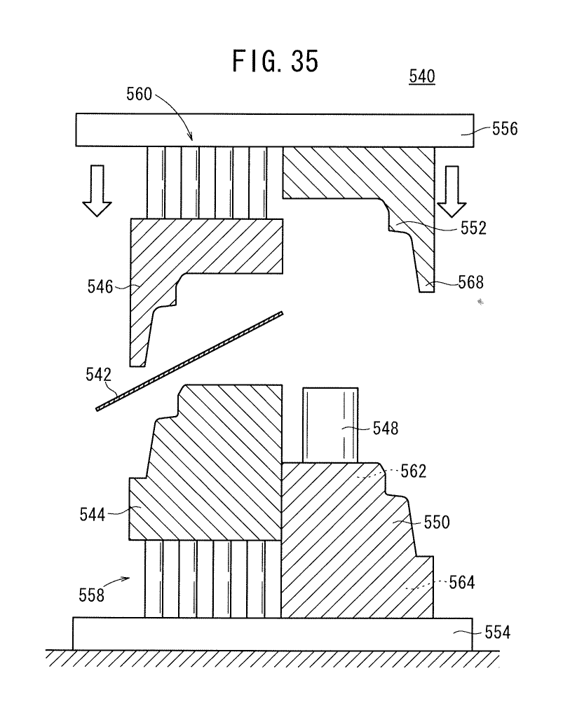

The automobile passenger compartment door 510 (joined article) is produced by a mold apparatus 540, a schematic vertical cross-sectional view of which is shown in FIG. 35. FIG. 35 shows a portion of the mold apparatus which shapes a door portion taken along line XXXIII-XXXIII of FIG. 32.

The mold apparatus 540, which is similar in construction to the mold apparatus 440, will be described below.

The mold apparatus 540 includes a first die 544 and a first punch 546 as a die assembly for shaping a workpiece 542 into the second door frame member 518, and a second die 550 and a second punch 552 for stamping a semi-solidified slurry 548 into the first joint member 526. The first die 544 and the second die 550 are mounted on a fixed plate 554, and the first punch 546 and the second punch 552 are mounted on a surface of a movable plate 556 which faces the fixed plate 554. The movable plate 556 is movable toward and away from the fixed plate 554.

The first die 544 is supported on the distal ends of a first rod train 558 which comprises the respective rods of a plurality of cylinders, not shown. When the cylinders are actuated in synchronism with each other to advance or retract the first rod train 558, the first die 544 is vertically displaced in unison with the first rod train 558.

The first punch 546 is supported on the distal ends of a second rod train 560 which comprises the respective rods of a plurality of cylinders, not shown. When the cylinders are actuated in synchronism with each other to advance or retract the second rod train 560, the second punch 552 is vertically displaced in unison with the second rod train 560.

The second die 550 is mounted on the fixed plate 554 adjacent to the first die 544. The semi-solidified slurry 548 is placed on a wide upper end face of the second die 550.

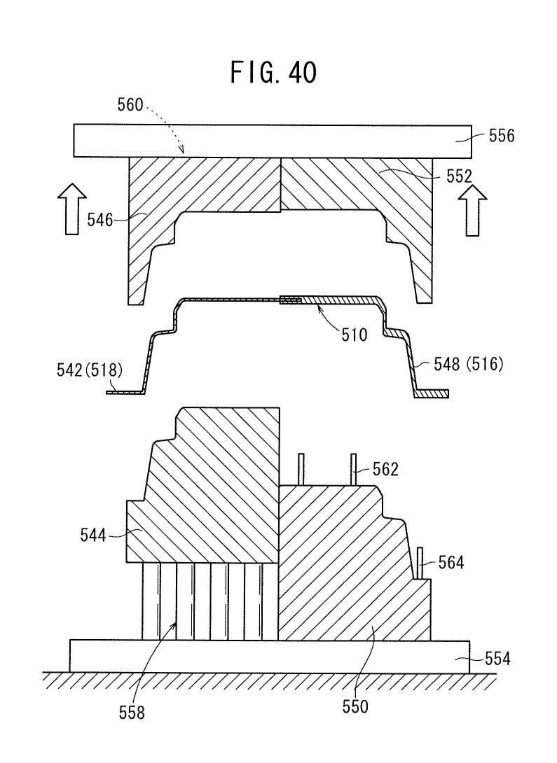

First knockout pins 562 and a second knockout pin 564 (see FIG. 40) are projectably and retractably embedded respectively in the upper end face and the upper surface of a right end portion of the second die shown in FIG. 35. When the first knockout pins 562 and the second knockout pin 564 project from the upper end face and the upper surface of the right end portion, the joined article is released from the mold apparatus.

The second punch 552 is a mold member for pressing the semi-solidified slurry 548. Specifically, the semi-solidified slurry 548 is pressed and compressed by the second punch 552 and flows.

When a lifting and lowering mechanism, not shown, is actuated, the movable plate 556 is moved toward and away from the fixed plate 554. When the movable plate 556 is moved toward the fixed plate 554, the mold apparatus is clamped. When the movable plate 556 is moved away from the fixed plate 554, the mold apparatus is opened.

A stamping method (a method of manufacturing a joined article) according to the fifth embodiment is carried out by the mold apparatus 540 thus constructed, as follows:

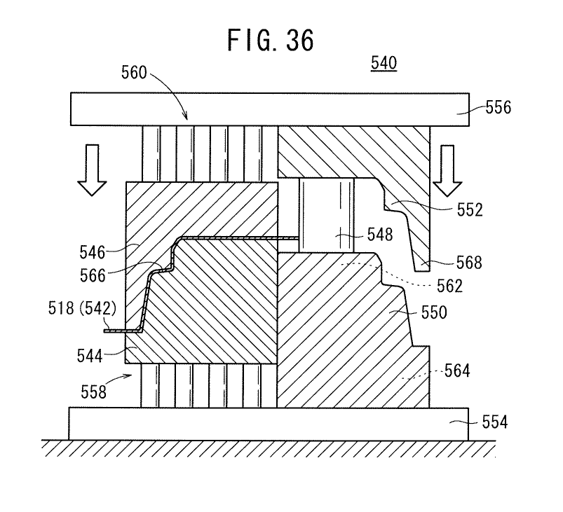

First, as shown in FIG. 35, the workpiece 542 is inserted between the first die 544 and the first punch 546. The semi-solidified slurry 548 is placed on the upper end face of the second die 550. The semi-solidified slurry 548 is put in a position that is spaced from the first die 544 by a prescribed distance, preferably 10 mm or greater. The workpiece 542 has an end disposed vertically between the upper and lower ends of the semi-solidified slurry (see FIG. 36).

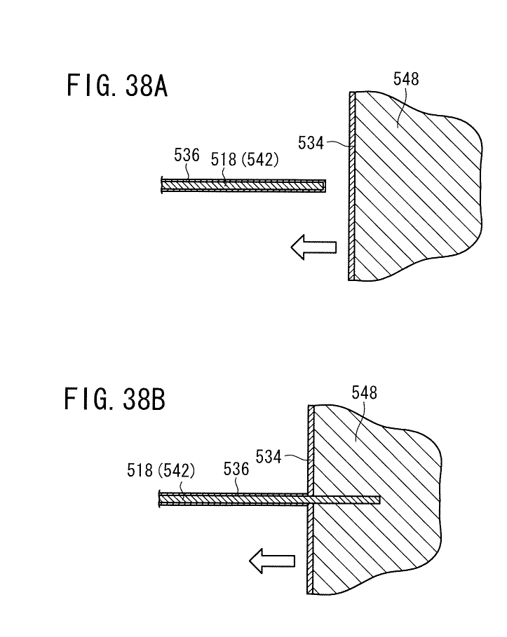

As described above, the workpiece 542 may be made of an aluminum alloy A5182, for example, and the semi-solidified slurry 548 may be made of an aluminum alloy AC4CH which is of a different alloy type from A5182. Oxide films 534, 536 (see FIGS. 33 and 38) as passivation films are present on the surfaces of the semi-solidified slurry 548 and the workpiece 542, the oxide films 534, 536 being formed when the surfaces are oxidized by oxygen in the atmosphere.

Then, as shown in FIG. 36, the lifting and lowering mechanism is actuated to lower the first punch 546 and the second punch 552 together with the movable plate 556. When the first punch 546 and the second punch 552 are lowered, the first die 544 and the second punch 552 jointly define a first cavity 566. The workpiece 542 is shaped complementarily to the first cavity 566, i.e., is shaped into a form corresponding to the second door frame member 518. The end of the second door frame member 518 projects from the first cavity 566 so as to extend toward the semi-solidified slurry 548.

At this time, the semi-solidified slurry 548 is not compressed.

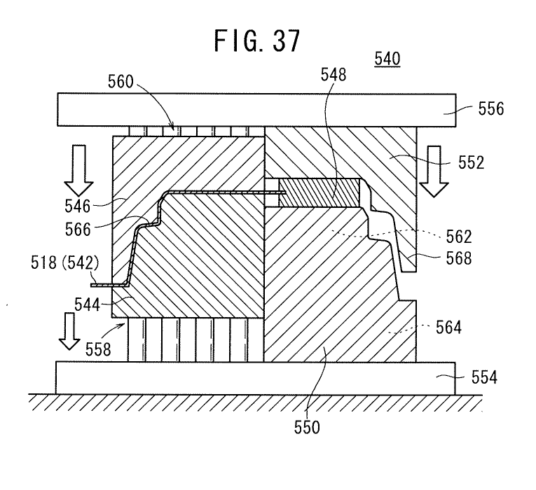

Then, as shown in FIG. 37, the lifting and lowering mechanism is actuated to lower the movable plate 556 further. The second punch 552 starts pressing the semi-solidified slurry 548, which is compressed and starts to flow. The second rod train 560 is synchronously retracted, thereby holding the first cavity 566 and the second door frame member 518 in position.

The portion of the semi-solidified slurry 548 which has flowed toward the first die 544 and the first punch 546 is initially spaced from the end of the second door frame member 518, as shown in FIG. 38A. As the semi-solidified slurry 548 flows on, it abuts against the end of the second door frame member 518. When the flowing of the semi-solidified slurry 548 progresses further, as shown in FIG. 38B, the end of the second door frame member 518 presses against the semi-solidified slurry 548, and then breaks the oxide film 534 by shearing force.

At this time, the end is embedded by a distance of about 5 mm. This state corresponds to the state shown in FIG. 37.

According to the fifth embodiment, the mold apparatus stays in this state for a prescribed time. Since the end of the second door frame member 518 is embedded in the semi-solidified slurry 548, heat is transferred from the semi-solidified slurry 548 to the second door frame member 518, the temperature of which then rises.

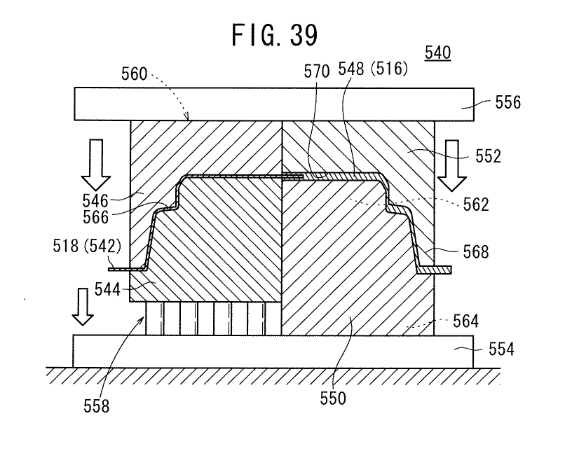

Finally, when the temperature of the second door frame member 518 becomes high enough to diffuse the metal element (e.g., Si) of the semi-solidified slurry 548 in the second door frame member 518 and also to diffuse the metal element (e.g., Mg) of the second door frame member 518 in the semi-solidified slurry 548, or when the temperature of the second door frame member 518 reaches 395° C. if the semi-solidified slurry 548 is made of AC4CH and the second door frame member 518 is made of A5182, the semi-solidified slurry 548 is shaped. In other words, as shown in FIG. 39, the movable plate 556 is lowered further.

The semi-solidified slurry 548 is thus compressed further and slides about 10 mm along both the lower end face and the upper end face of the second door frame member 518. The sliding movement breaks mainly the oxide film 534 on the surface of the second door frame member 518, and the end of the second door frame member 518 is embedded in the semi-solidified slurry 548 by about 15 mm. The oxide film 536 on the surface of the semi-solidified slurry 548 is also broken by the above sliding movement.

The semi-solidified slurry 548 which has slid or flowed is blocked by the first die 544 and the first punch 546, and a seal portion 568 of the second punch 552. Specifically, the semi-solidified slurry 548 is shaped complementarily to a second cavity 570 which is jointly defined by the first die 544, the first punch 546, the second die 550, and the second punch 552. At this time, the first rod train 558 is slightly retracted, lowering the first die 544. The movable plate 556 is thus easily lowered.

The oxide film 536 is present only on the surface of the second door frame member 518, and not within the second door frame member 518. As described above, the oxide film 534 on the surface of the semi-solidified slurry 548 is also broken. Therefore, the semi-solidified slurry 548 has good wettability with respect to the second door frame member 518. The end of the second door frame member 518 which is surrounded by the semi-solidified slurry 548 with good wettability is wetted and closely contacted by the inside of the semi-solidified slurry 548 (see FIG. 37). Furthermore, as the temperature of the second door frame member 518 has risen to a sufficient temperature of 395° C. or higher, the wetted close contact is further increased, allowing the semi-solidified slurry 548 and the second door frame member 518 to blend in well with each other with no gaps therebetween.

The oxide film 534 on the second door frame member 518 is broken, and is present only on the surface of the second door frame member 518, not within the second door frame member 518. As described above, the oxide film on the surface of the semi-solidified slurry 548 is removed. Since the semi-solidified slurry 548 is held in wetted close contact with the second door frame member 518, an element, e.g., Si, contained in the semi-solidified slurry 548 is diffused into the second door frame member 518. According to the fifth embodiment, at the same time that the diffusion progresses, the diffusion of an element, e.g., Mg, contained in the second door frame member 518 into the semi-solidified slurry 548 also progresses.

Then, the semi-solidified slurry 548 is cooled and solidified into the first joint member 526. The end of the second door frame member 518 is now connected to the first joint member 526 while avoiding the formation of a new oxide film between the end of the second door frame member 518 and the semi-solidified slurry 548.

As can be understood from the foregoing, the first joint member 526 and the second door frame member 518 are joined to each other by diffusion joining because, as described above, the element Si of the semi-solidified slurry 548 is diffused into the second door frame member 518 at the time the semi-solidified slurry 548 is molded.

Similarly, the first door frame member 516 and the third door frame member 520 are shaped in other areas in the mold apparatus 540. The first door frame member 516 and the third door frame member 520, together with the window frame member 522, are insert-molded by prescribed ones of the first joint member 526, the second joint member 528, the third joint member 530, and the fourth joint member 532. In this manner, the automobile passenger compartment door 510 is produced as a joined article wherein the ends of the members 516, 518, 520, 522 are joined by the joint members 526, 528, 530, 532.

Finally, as shown in FIG. 40, the lifting and lowering mechanism is actuated to lift the movable plate 556 to separate the first punch 546 and the second punch 552 from the first die 544 and the second die 550, thereby opening the mold apparatus. The first knockout pins 562 and the second knockout pin 564 are projected from the second die 550, releasing the automobile passenger compartment door 510.

In the automobile passenger compartment door 510 (joined article) thus produced, the ends of the members 516, 518, 520, 522 are joined to the joint members 526, 528, 530, 532 with a large joining strength because, as can be understood from the foregoing, the oxide films 534, 536 are prevented from being interposed between the ends of the members 516, 518, 520, 522 and the joint members 526, 528, 530, 532, and the ends and the joint members 526, 528, 530, 532 are joined to each other by diffusion joining.

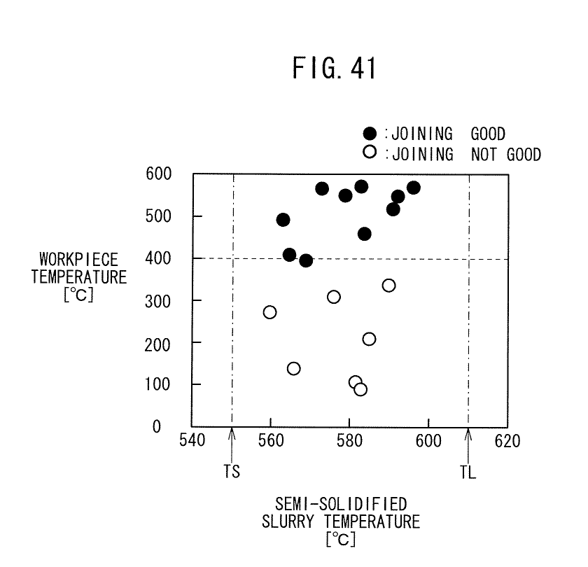

FIG. 41 is a graph showing the results of a check on degrees of joining achieved between the first joint member 526 and the second door frame member 518 by a stamping process carried out at various different temperatures of the semi-solidified slurry 548 and various different temperatures of the second door frame member 518. In FIG. 41, TS and TL refer to a solidus temperature and a liquidus temperature, respectively, at the time the semi-solidified slurry 548 is made of AC4CH. At temperatures between TS and TL, the semi-solidified slurry 548 is in a coexisting solid-liquid phase. The solid-phase ratio of the semi-solidified slurry 548 used in the fifth embodiment is in the range from about 30 to 70%. The second door frame member 518 is made of A5182.

In FIG. 41, black dots () represent temperatures at which the first joint member 526 and the second door frame member 518 were joined well, and white dots (◯) represent temperatures at which the first joint member 526 and the second door frame member 518 were joined insufficiently. It can be seen from the results that good joints are achieved if the temperature of the second door frame member 518 is 395° C.

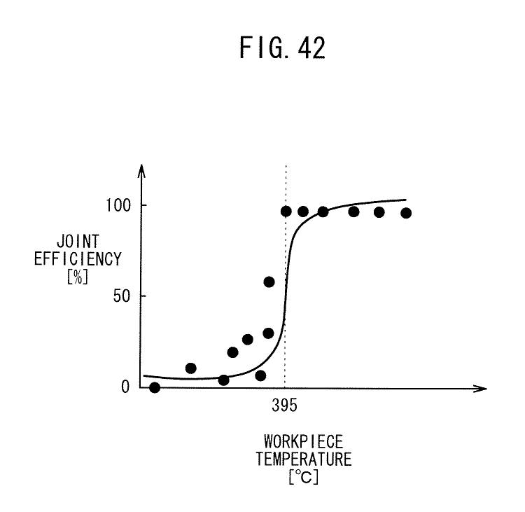

FIG. 42 is a graph showing the relationship between temperatures of the second door frame member 518 and joint efficiencies in the stamping process. It can be understood from FIG. 42 that the joint efficiency rises sharply from 395° C.

When the semi-solidified slurry 548 is made of AC4CH and the temperature of the second door frame member 518 is 395° C. or higher, the good joints are produced, possibly for the reasons that, as described above, the element Si of the semi-solidified slurry 548 is diffused into the second door frame member 518 and the element Mg of the second door frame member 518 is diffused into the semi-solidified slurry 548, so that the first joint member 526 and the second door frame member 518 are joined to each other by diffusion joining.

In the fifth embodiment described above, the semi-solidified slurry 548 is made of AC4CH and the temperature of the second door frame member 518 (A5182) as the workpiece is set to 395° C. or higher. However, if the semi-solidified slurry 548 or the second door frame member 518 is made of a different material, then the temperature of the second door frame member 518 may be set depending on the different material. The difference between the semi-solidified slurry 548 and the workpiece should preferably be 200° C. or lower irrespective of their materials.

In the fifth embodiment, the workpiece 542 is pressed into the second door frame member 518. However, the workpiece 542 may not be pressed, and only the semi-solidified slurry 548 may be stamped.

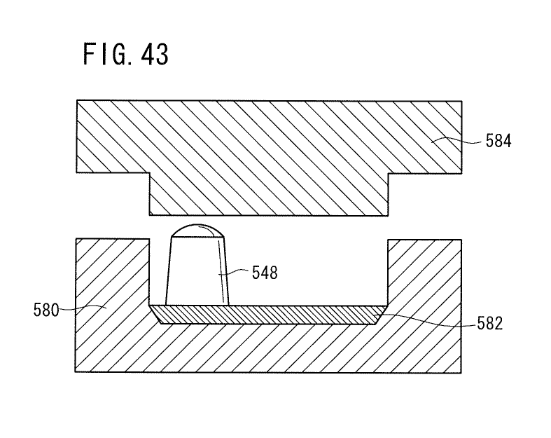

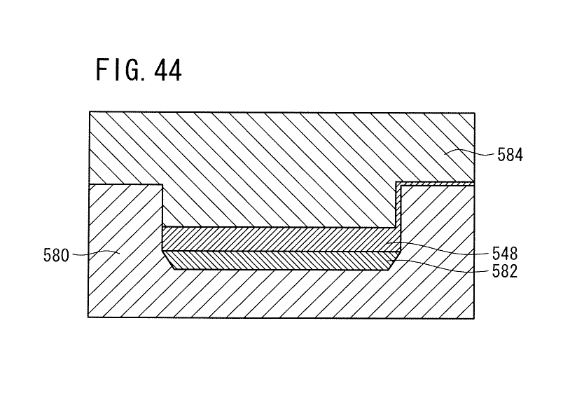

In the fifth embodiment, the end of the second door frame member 518 is inserted into the semi-solidified slurry 548, and when the temperature of the second door frame member 518 rises, the semi-solidified slurry 548 is caused to slide on both the lower end face and the upper end face of the second door frame member 518, thereby insert-molding the second door frame member 518. However, as shown in FIG. 43, after the semi-solidified slurry 548 is placed on an upper end face of a workpiece 582 placed in a lower mold 580, an upper mold 584 may be lowered to stamp the semi-solidified slurry 548, causing the semi-solidified slurry 548 to slide only along the upper end face of a workpiece 582, as shown in FIG. 44.

In this case, the oxide film on the surface of the semi-solidified slurry 548 and the oxide film 534 on the surface of the workpiece 582 are broken by the sliding movement of the semi-solidified slurry 548 on the workpiece 582. The exposed metal portions of the semi-solidified slurry 548 and the workpiece 582 are thus wetted and brought into close contact with each other, and a diffusion joint is formed between the workpiece 582 and the semi-solidified slurry 548, so that the workpiece 582 and the semi-solidified slurry 548 are joined to each other with a good joining strength. A joined article which is thus produced has a solidified mass of the semi-solidified slurry 548 joined to one end face of the workpiece 582.

In either case, instead of increasing the temperature of each workpiece with the semi-solidified slurry 548, the mold assembly may be preheated to transfer the heat thereof to each workpiece, thereby increasing the temperature of each workpiece. Alternatively, each workpiece may be preheated outside of the mold assembly, and after the temperature of each workpiece has increased, each workpiece may be placed in the mold assembly (cavity).

The joined article is not limited to the automobile passenger compartment door 510 in particular.

Finally, a sixth embodiment wherein vibrations are applied to a molten metal will be described below.

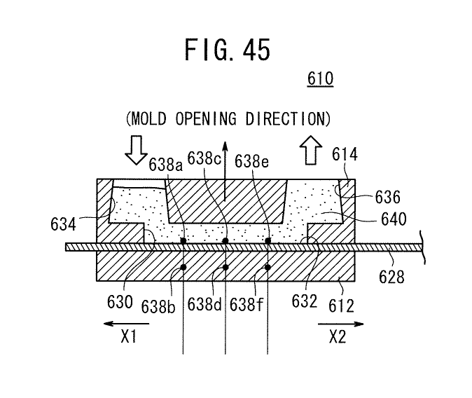

FIG. 45 is a schematic vertical cross-sectional view of a mold assembly 610 for carrying out a method of manufacturing a joined article according to the sixth embodiment. The mold assembly 610 comprises a lower mold 612, a first upper mold 614, and a second upper mold, not shown.

The lower mold 612 is of a substantially quadrilateral shape, and each of the first upper mold 614 and the second upper mold is in the shape of a substantially semi-rectangular parallelepiped. When the lower mold 612, the first upper mold 614, and the second upper mold are brought together and clamped, they jointly make up the mold assembly 610 which is in the shape of a substantially semi-rectangular parallelepiped, as shown in FIG. 45.

The first upper mold 614 and the second upper mold are displaced from the clamped state shown in FIG. 45 in directions perpendicular to the sheet of FIG. 45. As the first upper mold 614 and the second upper mold are thus displaced, they are moved away from the lower mold 612, whereupon the mold assembly is opened.

A workpiece 628 is slidably interposed between the upper end face of the lower mold and the lower end face of each of the first upper mold 614 and the second upper mold.

The workpiece 628 comprises a flat plate made of an aluminum alloy A5052 (JIS). The workpiece 628 has a right end portion in FIG. 45 associated with a vibration applying device (e.g., an actuator including a rotational motor), not shown, as a vibration applying means. The vibration applying device grips the right end portion of the workpiece 628 and reciprocally moves (i.e., slides) the workpiece 628 in the directions indicated by the arrows X1, X2 in FIG. 45, thereby applying vibrations to the workpiece 628. The vibrations should preferably have a frequency of 100 Hz or lower, or more preferably in the range from 13 to 50 Hz.

When the mold assembly is clamped, the first upper mold 614 and the second upper mold jointly define a cavity 630. The cavity 630 has a base portion 632 and first and second upstanding portions 634, 636 which rise substantially perpendicularly from the opposite ends of the base portion 632. The base portion 632 has a lower end facing the workpiece 628.

The first upstanding portion 634 has an upper end serving as a molten metal inlet, and the second upstanding portion 636 has an upper end serving as a gas vent port.

Six thermocouples 638a through 638f as temperature detectors are movably inserted in the lower mold 612. Of these thermocouples 638a through 638f, the thermocouples 638a, 638c, 638e have respective tip ends extending through the workpiece 628 and surrounded by a molten metal. The tip ends of the thermocouples 638a, 638c, 638e are fixed in certain positions within 1 mm from the upper end face of the workpiece 628. Therefore, the thermocouples 638a, 638c, 638e detect the temperature of a contact region of the molten metal 640 which is held in contact with the workpiece 628.

The remaining thermocouples 638b, 638d, 638f have respective tip ends inserted in the lower mold 612 so as to be fixed in certain positions within the lower mold 612. The thermocouples 638b, 638d, 638f serve to check how the temperature of the lower mold 612 changes when the temperature of the contact region is changed.

The tip ends of the thermocouples 638b, 638d, 638f are disposed substantially below the respective tip ends of the thermocouples 638a, 638c, 638e.

The method of manufacturing a joined article according to the sixth embodiment is carried out using the mold assembly 610 thus constructed, as follows:

First, the workpiece 628 is placed on the upper end face of the lower mold 612, and then the first upper mold 614 and the second upper mold are placed on the workpiece 628. The upper end face of the workpiece 628 is now exposed at the base portion 632 of the cavity 630. The right end in FIG. 45 of the workpiece 628 is gripped by the vibration applying device, which is then actuated to vibrate the workpiece 628 reciprocally in the directions indicated by the arrows X1, X2 in FIG. 45.

The frequency of the vibrations should preferably be 100 Hz or lower. If an ultrasonic vibrator is used to apply ultrasonic vibrations, then the ultrasonic vibrator is liable to be broken as it is of low impact resistance. In addition, since the ultrasonic vibrator suffers a transmission loss due to reflections, attenuations, etc., the ultrasonic vibrator finds it difficult to transmit vibrations, has a low output level in a continuous oscillation mode, and suffers frequency fluctuations at high temperatures. These shortcomings are prevented from occurring if a vibration applying device for applying vibrations in a low frequency range is used according to the sixth embodiment. The frequency of the vibrations should more preferably be in the range from 13 to 50 Hz.

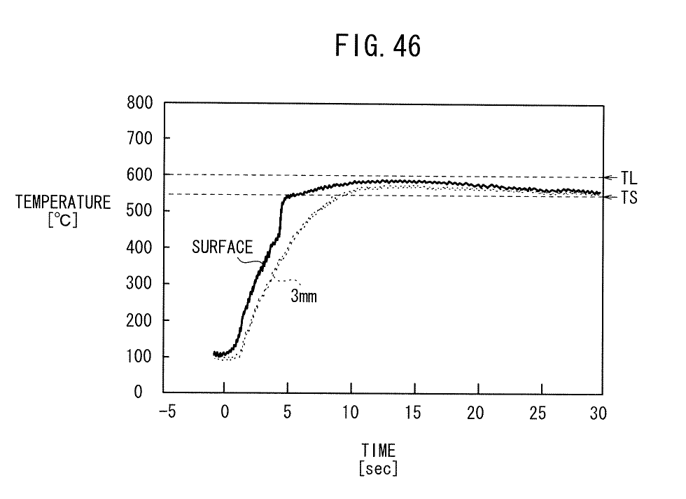

The mold assembly 610 is preheated so that the temperature of the workpiece 628 is about 200° C. as shown in FIG. 46.

Then, the molten metal 640 is poured through the molten metal inlet shown in FIG. 45. The molten metal 640 may be an aluminum alloy AC4CH (JIS), for example. Before the molten metal 640 is poured into the molten metal inlet, its temperature only needs to be higher than the liquidus temperature. In other words, the molten metal 640 is in a full liquid phase which does not contain a solid phase at all. In order to prevent the molten metal 640 from being solidified while it is being poured, the temperature of the molten metal 640 should preferably be set to a level which is about 20 to 50° C. higher than the liquidus temperature.

The molten metal 640 flows through the first upstanding portion 634 of the cavity 630 to the base portion 632 where the molten metal 640 is brought into contact with the upper end face of the workpiece 628 which is exposed in the base portion 632. In other words, the molten metal 640 flows along the upper end face of the workpiece 628 which is being vibrated. Therefore, the oxide film that is present on the surface of the molten metal 640 is broken. According to the sixth embodiment, the oxide film on the surface is broken, so that the molten metal 640 with increased wettability is brought into contact with the workpiece 628.

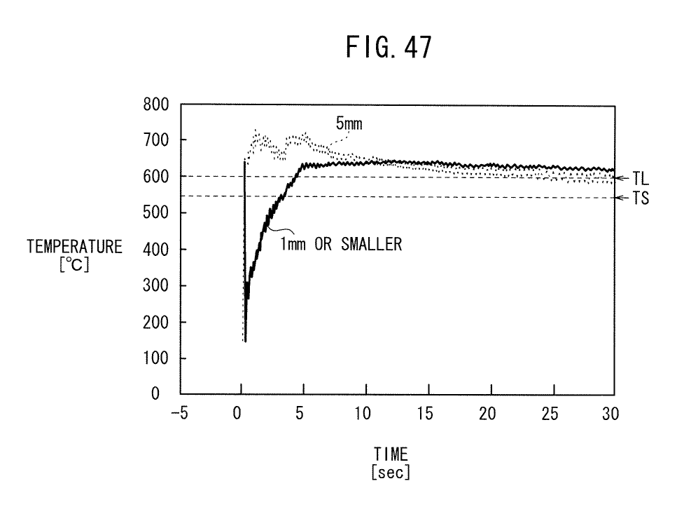

Since the temperature of the workpiece 628 is lower than that of the molten metal 640, the molten metal 640 is deprived of heat by the workpiece 628. Consequently, as shown in FIG. 47, the temperature of the region (contact region) of the molten metal 640 which is brought into contact with the workpiece 628 is quickly lowered below the liquidus temperature (TL in FIG. 47). The temperature of the contact region can be detected by the thermocouples 638a, 638c, 638e, as described above.

When the temperature is quickly lowered, a portion of the molten metal 640 is solidified (such solidification will hereinafter be referred to as initial solidification). The time that is consumed after the molten metal starts to be poured until the initial solidification starts is in the range from 0.5 to 1 second, for example, depending on the volume of the cavity 630 and the volume at which the molten metal 640 is poured per unit time.

According to the sixth embodiment, immediately before the initial solidification occurs as determined from the temperature of the contact region detected by the thermocouples 638a, 638c, 638e, the vibration applying device is inactivated to place the workpiece 628 at rest. In other words, the application of vibrations to the workpiece 628 is interrupted.

During this time, the pouring of the molten metal 640 is continued. Therefore, a high-temperature molten metal 640 which is newly poured and accumulated above the contact region is brought into contact with the contact region that has been solidified. The heat is transferred from the region (non-contact region) of the molten metal 640 which is held out of contact with the workpiece 628, to the contact region of the molten metal 640. As a result, as shown in FIG. 47, the temperature of the contact region rises beyond the liquidus temperature (TL in FIG. 47).

As the temperature rises, the contact region is re-melted into a liquid phase. The contact region is re-melted about 10 seconds after the molten metal starts to be poured, for example.

When it is confirmed from the temperature of the contact region that the contact region is re-melted, the vibration applying device is activated again to resume the application of vibrations to the workpiece 628. At this time, the frequency of the vibrations should preferably be 100 Hz or lower, or more preferably in the range from 13 to 50 Hz.

As the application of vibrations is resumed, the oxide film that is present on the upper end face of the workpiece 628 is broken. The workpiece 628 whose oxide film on its surface has been broken is brought into contact with the molten metal 640 whose oxide film has already been broken for increased wettability. Therefore, the upper end face of the workpiece 628 is wetted and closely contacted by the molten metal 640.

After the contact region is re-melted, the temperature of the molten metal 640 drops with time (see FIG. 47). The molten metal 640 now starts to be cooled and solidified, i.e., resolidified. The molten metal 640 starts to be resolidified about 25 seconds after the molten metal starts to be poured, for example. Immediately before the resolidification occurs, the vibration applying device is inactivated to place the workpiece 628 at rest, as is the case with the initial solidification. Therefore, when a predetermined time elapses, the molten metal 640 is fully solidified into a solidified mass. The temperature of the workpiece 628 also changes as the temperature of the molten metal 640 changes as described above (see FIG. 46).

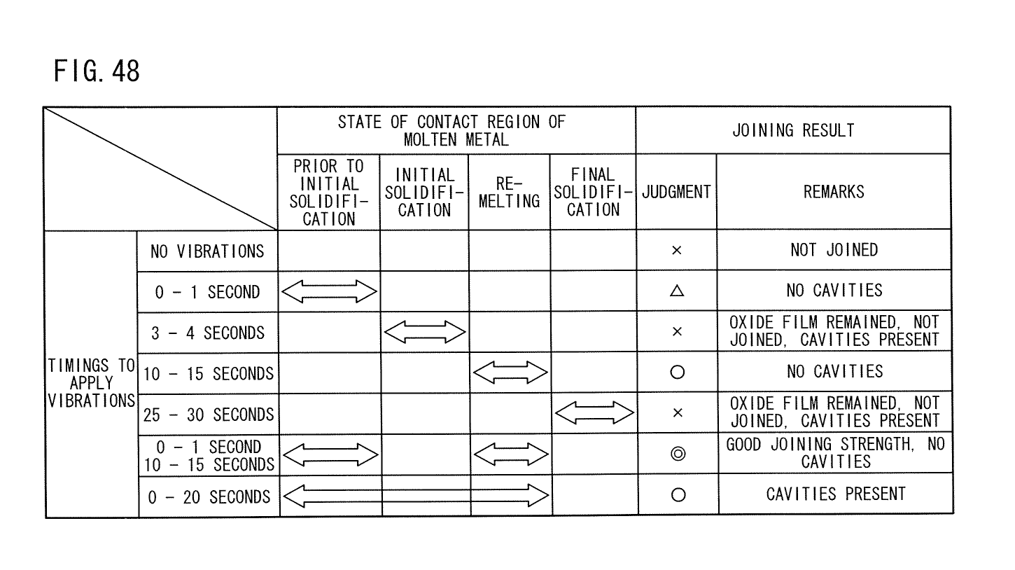

The joining strengths of joined articles which were obtained by the above process except that the vibrations were applied at different timings will be described below with reference to FIG. 48. The times shown in FIG. 48 are measured from 0 second at which the molten metal 640 starts to be poured.

First, the molten metal 640 was cooled and solidified with no vibrations applied from the pouring of the molten metal until the end of the resolidification. In this case, in all samples, oxide films remained on both the solidified mass and the workpiece 628, and the solidified mass and the workpiece 628 were not joined to each other. An electron probe microanalyzer (EPMA) was used to check whether there is an oxide film or not. Specifically, the results of the EPMA analysis were used to determine whether there is an oxide of MgO or the like on the joined interface or not. The same EPMA analysis was also used for the other joined articles.

Next, vibrations were applied only for 1 second before the initial solidification occurred. In this case, it was confirmed in most samples that the oxide film on the molten metal 640 was broken whereas the oxide film on the workpiece 628 remained. The ratio between those samples which had a sufficient joining strength and those samples which has an insufficient joining strength was about 1:1. In this case, no cavities were recognized.

Next, vibrations were applied only while the contact region was in a solid phase (from 3 second to 4 second after the start of the pouring of the molten metal) after the initial solidification was finished. In this case, no joining occurred in all samples. Cavities were confirmed in some samples.

Next, vibrations were applied only while the contact region was melted again and in a liquid phase (from 10 second to 15 second after the start of the pouring of the molten metal) after the initial solidification was finished. In this case, the oxide films on both the molten metal 640 and the workpiece 628 were broken in most samples. The ratio between those samples which had a sufficient joining strength and those samples which has an insufficient joining strength was about 3:1.

Next, vibrations were applied immediately after the contact region started to be resolidified into a solid phase (from 25 second to 30 second after the start of the pouring of the molten metal). In this case, in all samples, it was recognized that oxide films remained on both the workpiece 628 and the solidified mass. Also, in all samples, no joining occurred and cavities were confirmed.

Next, vibrations were applied both for 1 second prior to the initial solidification and while the contact region was melted again and in a liquid phase (from 10 second to 15 second after the start of the pouring of the molten metal). In this case, it was confirmed in all samples that the oxide films on both the molten metal 640 and the workpiece 628 were broken and cavities were not present. In all samples, a sufficient joining strength was achieved.

Finally, vibrations were uninterruptedly applied from the start of the pouring of the molten metal until the end of the resolidification (from 0 second to 20 second after the start of the pouring of the molten metal). In this case, although the ratio between those samples which had a sufficient joining strength and those samples which has an insufficient joining strength was about 3:1, cavities were confirmed in somewhat many samples.

As can be understood from the foregoing, a joined article free of cavities is produced by applying vibrations only while the region (contact region) of the molten metal 640 which is held in contact with the workpiece 628 is in a liquid phase. In particular, a joined article which exhibits a sufficient joining strength and ductility and which is free of cavities can be produced if vibrations are applied until the molten metal 640 is initially solidified and while the molten metal 640 is placed in a re-melted state.

The reason why cavities are formed by applying vibrations while the contact region is in a solid phase appears to be that the contact region and the non-contact region are agitated into an agitated solid-liquid phase. According to the sixth embodiment, vibrations are applied to the workpiece 628 only while the contact region is in a liquid phase, as described above. It is considered that since an agitated solid-liquid phase is avoided, cavities are prevented from being formed.

In as much as the oxide films on both the molten metal 640 and the workpiece 628 are broken by vibrating the workpiece 628, the wettability of the molten metal 640 with respect to the workpiece 628 is increased. Therefore, the joining strength between the workpiece 628 and the solidified mass is excellent.

While the molten metal 640 is thus solidified, the temperature of the lower mold 612 is detected by the thermocouples 638b, 638d, 638f, and changes in the temperature of the contact region and changes in the temperature of the lower mold 612 are recorded. The correlation between the temperature of the contact region and the temperature of the lower mold 612 can be found from the record data.

If the mold assembly 610 is a prototype, for example, then it is possible to estimate, with respect to mass-production mold assemblies, the temperature of the contact region of the molten metal 640 which contacts the workpiece 628 based on the above correlation simply by checking changes in the temperature of the lower mold 612. Therefore, it is not necessary to have the thermocouples 638a, 638c, 638e which extend through the workpiece 628.

Even if the workpiece 628 is made of an alloy different from A5052 and the molten metal 640 is an alloy different from AC4CH, the temperature of the contact region can be estimated based on the above correlation by checking changes in the temperature of the lower mold 612.

Accordingly, once the above correlation is checked, it is possible to estimate the temperature of the contact region simply by detecting the temperature of the lower mold 612.

FIG. 46 also shows changes in the temperature of the workpiece 628 detected by the thermocouples 638a, 638c, 638e in positions that are located at the lower mold 612 side and spaced 3 mm from the interface between the molten metal 640 and the workpiece 628. FIG. 47 also shows changes in the temperature of the molten metal 640 detected by the thermocouples 638a, 638c, 638e in positions which project 5 mm from the upper end face of the workpiece 628, i.e., which are spaced 5 mm from the interface between the molten metal 640 and the workpiece 628.

It can be seen from FIGS. 46 and 47 that there are temperature differences and different temperature changes between the contact region and the positions spaced from the contact region. By referring to FIG. 47 showing changes in the temperature of the molten metal 640 at the positions spaced 5 mm from the interface between the molten metal 640 and the workpiece 628, it can be recognized that it is not easy to find out that the temperature of the contact region of the molten metal 640 has become lower than the solidus temperature (TS in FIG. 47).

As can be understood from the foregoing, it is important to detect the temperature of the contact region in order to confirm whether there is a solid phase in the contact region of the molten metal 640 or not, or stated otherwise, in order to determine appropriate timings to apply vibrations and stop applying vibrations.

In the sixth embodiment, vibrations are applied to the workpiece 628 by horizontally reciprocally moving the workpiece 628 in the form of a flat plate. However, vibrations may be applied to a workpiece by rotating the workpiece, depending on the shape of the workpiece.

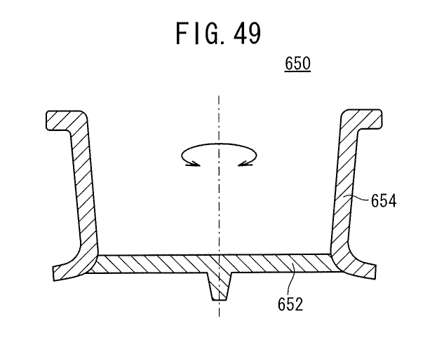

For example, a wheel 650 shown in FIG. 49 is produced by placing a disk 652 obtained by press-shaping, in an unillustrated mold assembly, and pouring a molten metal into the cavity of the mold assembly to form a rim 654. At this time, the disk 652 is rotated so as to keep portions of the disk 652 and the molten metal in contact with each other at all times. Since the disk 652 and the molten metal are prevented from being separated from each other, any joining failure between the rim 654 and the disk 652 is avoided.

A joined article may be a so-called insert-molded article where a workpiece is partly or wholly insert-molded by a solidified mass.

The workpiece and the molten metal may be of any metals and are not limited to the above aluminum alloys.

The time at which the initial solidification starts, the time until the re-melting occurs, and the time at which the resolidification starts may be checked in advance for each mold assembly and each type of molten metal, and timings for applying vibrations may be determined based on the checked times for mass-producing joined articles. Each of the above times may easily be recognized by monitoring the temperature of the contact region of the molten metal with thermocouples or the like, as described above.

1. A method of manufacturing a joined article of a workpiece which is partly or wholly previously placed in a mold assembly and a solidified mass of a molten metal poured in the mold assembly or a semi-solidified slurry which is previously placed, together with the workpiece, in the mold assembly, comprising:
causing the semi-solidified slurry or the molten metal to flow relatively on an end face of the workpiece while producing friction between the workpiece and the semi-solidified slurry or the molten metal, the friction being large enough to break a passivation film which is present on a surface of the molten metal or the semi-solidified slurry.

2. A method of manufacturing a joined article, comprising the steps of:
placing at least one semi-solidified slurry and at least two workpieces in a mold assembly;
clamping the mold assembly to mold the semi-solidified slurry complementarily in shape to a cavity, and causing the semi-solidified slurry to flow to respective insert-molded regions of the workpieces; and
solidifying the semi-solidified slurry;
wherein the semi-solidified slurry which has flowed to the insert-molded regions is insert-molded around the insert-molded regions.

3. The method according to claim 2, wherein the mold assembly is clamped with the semi-solidified slurry being disposed between the workpieces.

4. The method according to claim 2, wherein the mold assembly is clamped with the semi-solidified slurry being disposed on the workpieces.

5. A method of manufacturing a joined article by joining a semi-solidified slurry and a workpiece which are placed in a mold assembly to each other, comprising the steps of:
forming a ridge on the mold assembly or the workpiece in an area through which the semi-solidified slurry flows;
causing the ridge to form a restriction when the mold assembly is clamped to form a cavity;
applying a load to the semi-solidified slurry thereby to cause the semi-solidified slurry to flow through the restriction; and
joining at least a region of the workpiece which is positioned upstream of the ridge with respect to a direction in which the semi-solidified slurry flows, to the semi-solidified slurry.

6. The method according to claim 5, wherein the restriction has a cross-sectional area reduction ratio in the range from 10 to 40%.

7. A method of manufacturing a joined article by joining a semi-solidified slurry and a workpiece to each other, comprising the steps of:
supporting the workpiece with a first mold;
placing the semi-solidified slurry on an end face of the workpiece;
forming a space surrounding the semi-solidified slurry with the end face of the workpiece, a second mold, and a slurry outflow preventing member; and
pressing the semi-solidified slurry with the second mold to slide on the end face of the workpiece;
wherein the slurry outflow preventing member blocks the semi-solidified slurry which flows by being pressed by the second mold.

8. The method according to claim 7, further comprising the step of:
pressing the workpiece with a third mold to shape the workpiece.

9. An apparatus for manufacturing a joined article by joining a semi-solidified slurry and a workpiece to each other, comprising:
a first mold for supporting the workpiece;
a second mold for pressing the semi-solidified slurry which is placed on an end face of the workpiece; and
a slurry outflow preventing member which cooperates with the end face of the workpiece and the second mold to define a space surrounding the semi-solidified slurry;
wherein the slurry outflow preventing member blocks the semi-solidified slurry which flows by being pressed by the second mold.

10. The apparatus according to claim 9, further comprising:
a third mold for pressing the workpiece, wherein the third mold shapes the workpiece.

11. A joined article which is insert-molded such that an end of a workpiece is surrounded by a solidified mass of a semi-solidified slurry,
wherein the end breaks through an oxide film on the surface of the solidified mass and is joined to the solidified mass in the inside of the solidified mass where no oxide film is present.

12. A method of manufacturing a joined article by deforming a semi-solidified slurry placed in a mold assembly by stamping to insert-mold an end of a workpiece and then solidifying the semi-solidified slurry, comprising:
causing the end of the workpiece to abut against the semi-solidified slurry, pressing the end relatively against the semi-solidified slurry to cause the end to break through an oxide film on a surface of the semi-solidified slurry and then embedding the end in the semi-solidified slurry.

13. The method according to claim 12, wherein the end of the workpiece is disposed vertically between lower and upper end portions of the semi-solidified slurry, and the semi-solidified slurry is stamped.

14. The method according to claim 12, wherein the workpiece is pressed to shape.

15. A method of manufacturing a joined article by joining a semi-solidified slurry and a workpiece which are placed in a mold assembly to each other, comprising the steps of:
before or after the workpiece is placed in the mold assembly, bringing the workpiece to a temperature at which a metal element contained in the semi-solidified slurry can be diffused in the workpiece and a metal element contained in the workpiece can be diffused in the semi-solidified slurry; and
molding the semi-solidified slurry placed, together with the workpiece, in the mold assembly, and causing the semi-solidified slurry to slide on at least one end face of the workpiece.

16. The method according to claim 15, wherein the workpiece is made of an aluminum alloy of an alloy type while the semi-solidified slurry is made of an aluminum alloy of an alloy type which are different from the alloy type of the workpiece.

17. The method according to claim 16, wherein the semi-solidified slurry is molded while the workpiece is held at a temperature of 395° C. or higher.

18. The method according to claim 15, wherein the semi-solidified slurry slides over a distance of 10 mm or greater.

19. The method according to claim 15, further comprising the step of:
increasing the temperature of the workpiece with heat transferred from the semi-solidified slurry.

20. The method according to claim 15, further comprising the step of:
increasing the temperature of the workpiece by preheating the mold assembly.

21. The method according to claim 15, further comprising the steps of:
increasing the temperature of the workpiece by preheating the workpiece outside of the mold assembly; and
thereafter, placing the workpiece in the mold assembly.

22. A method of manufacturing a joined article of a workpiece which is partly or wholly previously placed in a mold assembly and a solidified mass of a molten metal poured in the mold assembly, comprising:
controlling vibration applying means to apply vibrations to the workpiece when the temperature of a contact region of the molten metal which is held in contact with the workpiece is equal to or higher than a liquidus temperature, and to stop applying vibrations when the temperature drops below the liquidus temperature.

23. The method according to claim 22, wherein the vibrations are applied to the workpiece while the contact region is kept in a liquid phase immediately after the molten metal is brought into contact with the workpiece to form the contact region, and while the contact region that has been solidified by being deprived of heat by the workpiece is brought back into a liquid phase by heat transferred from a non-contact region of the molten metal which is held out of contact with the workpiece.

24. The method according to claim 22, wherein the vibrations are applied to the workpiece at a frequency of 100 Hz or lower.

25. The method according to claim 22, further comprising:
rotating the workpiece thereby to apply the vibrations to the workpiece.
